(19) United States
(12) Patent Application Publication
(10) Pub. No.: US 2026/0176167 A1
(43) Pub. Date: Jun. 25, 2026

(54) CARTRIDGE AND METHOD FOR CLEANING WATER LINES OF AN APPLIANCE

(71) Applicant: ELECTROLUX HOME PRODUCTS, INC., Charlotte, NC (US)

(72) Inventors: Thomas W. MCCOLLOUGH, Anderson, SC (US); Zhuochen SHI, Clemson, SC (US)

(73) Assignee: ELECTROLUX HOME PRODUCTS, INC., Charlotte, NC (US)

(21) Appl. No.: 19/128,798

(22) PCT Filed: Nov. 9, 2023
(86) PCT No.: PCT/US2023/079246

§ 371 Date: May 9, 2025

Related U.S. Application Data
(60) Provisional application No. 63/423,976, filed on Nov. 9, 2022.
(60) Provisional application No. 63/541,316, filed on Sep. 29, 2023.

(51) Int. Cl. C02F 1/28; C02F 1/00

(52) U.S. Cl. CPC C02F 1/283; C02F 1/001; C02F 1/003; C02F 2201/006

(57) ABSTRACT

Embodiments of a cartridge, a cleaning media formulated to be combined with water to form a liquid solution for delivery to an appliance through a water filter cartridge, and methods of use are described herein. The cleaning media is formulated to be diluted in water from the water filter cartridge manifold to form the liquid solution before delivery through the water filter cartridge manifold to the one or more water lines to substantially eliminate bacteria in the one or more water lines of the appliance.

### CROSS-REFERENCE TO RELATED APPLICATIONS

The present application claims priority to and benefit from U.S. Provisional Patent Application No. 63/423,976, filed Nov. 9, 2022, and U.S. Provisional Patent Application No. 63/541,316, filed Sep. 29, 2023. Each of the foregoing patent applications is hereby incorporated by reference in its entirety.

### FIELD OF THE INVENTION

The present invention embraces a cartridge and method for cleaning water lines of an appliance (e.g., a refrigerator, a freezer, and/or the like).

### BACKGROUND

Appliances, such as refrigerators, freezers, and/or the like, may include one or more components, such as a water dispenser, an ice maker, and/or the like, which use water from a water supply (e.g., a household water supply and/or the like). Such appliances typically include a water filter that filters water received from the water supply before the water is provided to the one or more components. The components to which the water is provided, such as one or more water lines, fittings, or other plumbing mechanisms are in constant or frequent contact with water. Over time, unintended growth of microbial pathogens such as bacteria may occur within the components. User access to the internal cavities of these components is limited, and as such there is a need for a cartridge and method for cleaning water lines of an appliance.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. This summary presents some concepts of one or more embodiments of the present invention in a simplified form as a prelude to the more detailed description that is presented later.

In one aspect, the present invention embraces a cartridge for cleaning water lines of an appliance. The cartridge may include a housing defining a cavity, a fluid inlet and a fluid outlet positioned on the housing and in fluid communication with the cavity, and the fluid inlet and the fluid outlet may be configured to interface with a water filter cartridge manifold of an appliance, and a cleaning media disposed within the cavity.

In some embodiments, the housing may be a blow-molded housing.

In some embodiments, the housing may be configured to provide access to the cavity.

In some embodiments, a head may include the fluid inlet and the fluid outlet, wherein the head further includes a key extending radially outward from the head.

In some embodiments, the head may include at least one displaceable latch feature extending longitudinally from the head.

In some embodiments, the cleaning media may include a colorant.

In some embodiments, the cleaning media oxidizes cell membranes of bacteria in one or more water lines of the appliance and reduces an intracellular pH of bacterial cells of the bacteria.

In some embodiments, the cleaning media may be a liquid solution to be delivered through the water filter cartridge manifold to one or more water lines.

In some embodiments, the cleaning media may be formulated to be diluted in water, while the fluid inlet and the fluid outlet interface with the water filter cartridge manifold, to form a liquid solution before delivery through the water filter cartridge manifold to one or more water lines.

In some embodiments, the cleaning media may include at least one of a cleaning fluid, a concentrated cleaning fluid, or a solid concentrate.

In some embodiments, dissolving the solid concentrate forms the cleaning fluid.

In some embodiments, dissolving the solid concentrate forms a liquid solution.

In some embodiments, the liquid solution may have a concentration of between about 2 percent and 4 percent of a cleaning chemical.

In some embodiments, the liquid solution may include peracetic acid.

In some embodiments, the liquid solution may have a concentration of about 5 percent or less of peracetic acid.

In some embodiments, the liquid solution may have a concentration of between about 3 percent and 4 percent of peracetic acid.

In some embodiments, the liquid solution may have a concentration of a cleaning chemical of at least about 0.01 percent throughout a whole length of the one or more water lines.

In some embodiments, the liquid solution may be in the one or more water lines, the liquid solution may have a concentration of a cleaning chemical of at least about 0.25 percent throughout a whole length of the one or more water lines.

In some embodiments, the one or more water lines of the appliance have a total length, and the cleaning media may be formulated such that the liquid solution may have sufficient concentration of the cleaning media through the total length of the one or more water lines to reduce a bacterial count in the one or more water lines of the appliance.

In some embodiments, the one or more water lines of the appliance have a total length, and the cleaning media may be formulated such that the liquid solution may have sufficient concentration of the cleaning media through the total length of the one or more water lines to substantially eliminate bacteria in the one or more water lines of the appliance after the liquid solution may be positioned within the one or more water lines for at least a predetermined period of time.

In some embodiments, the cleaning media reduces mold at ends of the one or more water lines of the appliance.

In some embodiments, the cleaning media substantially eliminates bacteria in the one or more water lines of the appliance.

In another aspect, the present invention embraces a method for manufacturing a cartridge. The method may include molding a pre-form, and the pre-form may include a head including a fluid inlet, a fluid outlet, and a cavity in fluid communication with the head, heating the pre-form to a predetermined temperature, inserting the pre-form into a molding chamber including mold pieces, inserting an injection device into the cavity, and supplying a pressurized gas to the injection device until the cavity expands to the mold pieces.

In some embodiments, the method may further include filling the cavity with a cleaning media, and sealing the fluid inlet and the fluid outlet.

In some embodiments, the head may include a key extending radially outward from the head.

In some embodiments, the head may include at least one displaceable latch feature extending longitudinally from the head.

In yet another aspect, the present invention embraces a cleaning media formulated to be combined with water to form a liquid solution for delivery through a water filter cartridge manifold of an appliance to one or more water lines of the appliance, and the cleaning media in the liquid solution reduces a bacterial count in the one or more water lines of the appliance.

In some embodiments, the cleaning media in the liquid solution reduces mold at ends of the one or more water lines.

In some embodiments, the cleaning media may be a solid formulated to be dissolved in water from the water filter cartridge manifold to form the liquid solution before delivery through the water filter cartridge manifold to the one or more water lines.

In some embodiments, the cleaning media may be a liquid formulated to be diluted in water to form the liquid solution.

In some embodiments, the cleaning media may be the liquid solution.

In some embodiments, the cleaning media may be a liquid formulated to be diluted in water within the water filter cartridge manifold to form the liquid solution before delivery through the water filter cartridge manifold to the one or more water lines.

In some embodiments, the cleaning media may be formulated such that, before delivery through the water filter cartridge manifold to the one or more water lines, the liquid solution may have a concentration of between about 2 percent and 4 percent of a cleaning chemical.

In some embodiments, the liquid solution may include peracetic acid.

In some embodiments, the liquid solution may have a concentration of about 5 percent or less of peracetic acid.

In some embodiments, the liquid solution may have a concentration of between about 3 percent and 4 percent of peracetic acid.

In some embodiments, the cleaning media may be formulated such that, when the liquid solution may be in the one or more water lines, the liquid solution may have a concentration of a cleaning chemical of at least about 0.01 percent throughout a whole length of the one or more water lines.

In some embodiments, the cleaning media may be formulated such that, when the liquid solution may be in the one or more water lines, the liquid solution may have a concentration of a cleaning chemical of at least about 0.25 percent throughout a whole length of the one or more water lines.

In some embodiments, the cleaning media in the liquid solution substantially eliminates bacteria in the one or more water lines of the appliance.

In some embodiments, the liquid solution may be formulated to substantially eliminate bacteria in the one or more water lines of the appliance after the liquid solution may be positioned within the one or more water lines for a predetermined amount of time.

In some embodiments, the cleaning media in the liquid solution substantially eliminates bacteria in the one or more water lines of the appliance after the liquid solution may be positioned within the one or more water lines for a predetermined amount of time.

In some embodiments, the one or more water lines of the appliance have a total length, and the cleaning media may be formulated such that the liquid solution may have sufficient concentration of the cleaning media through the total length of the one or more water lines to reduce the bacterial count in the one or more water lines of the appliance.

In some embodiments, the one or more water lines of the appliance have a total length, and the cleaning media may be formulated such that the liquid solution may have sufficient concentration of the cleaning media through the total length of the one or more water lines to substantially eliminate bacteria in the one or more water lines of the appliance after the liquid solution may be positioned within the one or more water lines for at least a predetermined period of time.

In some embodiments, the cleaning media may be formulated such that the liquid solution may include a mixture of acetic acid and hydrogen peroxide.

In some embodiments, the cleaning media may be formulated such that the liquid solution may have a concentration of about 5 percent or less of peracetic acid.

In some embodiments, the cleaning media may be formulated such that the liquid solution may have a concentration of between about 3 percent and 4 percent of peracetic acid.

In some embodiments, the cleaning media may include a colorant.

In some embodiments, the cleaning media oxidizes cell membranes of bacteria in the one or more water lines of the appliance and reduces an intracellular pH of bacterial cells of the bacteria.

In yet another aspect, the present invention embraces a method for cleaning water lines of an appliance. The method may include introducing cleaning fluid from a source into water lines of an appliance, and the source may include a container of the cleaning fluid, and the container may be attached to a water filter cartridge manifold of the appliance, after introducing the cleaning fluid from the source, waiting at least a predetermined period of time, and after waiting at least the predetermined period of time, introducing water into the water lines to push the cleaning fluid out of the water lines.

In some embodiments, the method may further include introducing additional water into the water lines to rinse the water lines.

In some embodiments, the cleaning fluid may include a cleaning chemical.

In some embodiments, the cleaning fluid may have a concentration of the cleaning chemical of at least about 0.25 percent throughout a whole length of the one or more water lines.

In some embodiments, the cleaning fluid may have a concentration of the cleaning chemical of at least about 0.01 percent throughout a whole length of the one or more water lines.

In some embodiments, introducing cleaning fluid from the source into the water lines of the appliance may include introducing cleaning fluid from the source to substantially fill one or more of the water lines of the appliance.

In some embodiments, the container may include concentrate, and the method may include, before introducing the cleaning fluid from the source into the water lines of the appliance, introducing water into the container to dilute the concentrate to form the cleaning fluid.

In some embodiments, the container may include solid concentrate, and the method may include, before introducing the cleaning fluid from the source into the water lines of the appliance, introducing water into the container to dissolve the solid concentrate to form the cleaning fluid.

In some embodiments, the appliance may be a refrigerator.

In some embodiments, the method may include providing the container, wherein the container comprises the cartridge of any one of the preceding embodiments.

In some embodiments, the head of the cartridge may include a key extending radially outward from the head.

In some embodiments, the head of the cartridge may include at least one displaceable latch feature extending longitudinally from the head.

In yet another aspect, the present invention embraces a method for cleaning water lines of an appliance. The method may include causing an appliance to introduce cleaning fluid from a container into one or more water lines of the appliance, and the container may be attached to a water filter cartridge manifold of the appliance, after introducing the cleaning fluid from the container, waiting at least a predetermined period of time, and after waiting at least the predetermined period of time, causing the appliance to introduce water into the water lines to push the cleaning fluid out of the water lines.

In some embodiments, the appliance may be a refrigerator.

In some embodiments, the method may include, before causing the appliance to introduce the cleaning fluid from the container, positioning the container such that it may be in fluid communication with the water filter cartridge manifold of the appliance.

In some embodiments, causing the appliance to introduce the cleaning fluid from the container may include causing the appliance to introduce the cleaning fluid from the container to substantially fill the one or more of the water lines of the appliance.

In some embodiments, causing the appliance to introduce water into the water lines may include, after introducing the cleaning fluid from the container, replacing the container with a water filter cartridge.

In some embodiments, the method may include providing the container, and the container may include the cartridge of any one of the preceding embodiments.

In some embodiments, the container may include the cartridge of any one of the preceding embodiments, and the method may include, prior to introducing the cleaning fluid from the container, manipulating the housing to obtain access to the removable filtration media, removing the removable filtration media from the cavity, positioning the cleaning fluid in the cavity, and manipulating the housing to close the cavity.

In some embodiments, the method may include, before causing the appliance to introduce the cleaning fluid from the container, causing the appliance to introduce water into the container to dilute a concentrate to form the cleaning fluid.

In some embodiments, the method may include, before causing the appliance to introduce the cleaning fluid from the container, causing the appliance to introduce water into the container to dissolve a solid concentrate to form the cleaning fluid.

In some embodiments, the method may include prior to introducing the cleaning fluid from the container, removing the container from the appliance, and, after manipulating the housing to close the cavity, inserting the container into the appliance and engaging the fluid inlet and the fluid outlet with the water filter cartridge manifold of the appliance.

In some embodiments, the method may include, after introducing the cleaning fluid from the container, manipulating the housing to obtain access to the cavity within the housing, rinsing the container to remove residual cleaning fluid from the container, inserting the removable filtration media or another removable filtration media into the cavity, and manipulating the housing to close the cavity.

In some embodiments, the method may include, before manipulating the housing to obtain the access to the cavity within the housing, removing the container from the appliance, and, after manipulating the housing to close the cavity, inserting the container into the appliance and engaging the fluid inlet and the fluid outlet with the water filter cartridge manifold of the appliance.

In yet another aspect, the present invention embraces an appliance. The appliance may include a water filter cartridge manifold configured to receive a water filter cartridge, one or more water lines in fluid communication with the water filter cartridge manifold, at least one processing device, and at least one non-transitory storage device including computer-executable program code that, when executed by the at least one processing device, causes the at least one processing device to introduce, through the water filter cartridge manifold, cleaning fluid from a source into the one or more water lines, after introducing the cleaning fluid from the source, wait at least a predetermined period of time, and after waiting at least the predetermined period of time, introduce, through the water filter cartridge manifold, water into the one or more water lines to push the cleaning fluid out of the one or more water lines.

In some embodiments, the water filter cartridge may include the cartridge of any one of the preceding embodiments.

In some embodiments, the appliance may be a refrigerator.

In some embodiments, the head of the cartridge may include a key extending radially outward from the head.

In some embodiments, the head of the cartridge may include at least one displaceable latch feature extending longitudinally from the head.

The features, functions, and advantages that have been discussed may be achieved independently in various embodiments of the present invention or may be combined with yet other embodiments, further details of which may be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates a perspective view of a water filter cartridge, in accordance with an embodiment of the invention;

FIG. 2A illustrates a cross-sectional perspective view of a water filter cartridge, in accordance with an embodiment of the invention;

FIG. 2B illustrates a cross-sectional perspective view of a water filter cartridge including a cleaning media, in accordance with an embodiment of the invention;

FIG. 3A illustrates a perspective view of an interface mechanism, in accordance with an embodiment of the invention;

FIG. 3B illustrates a perspective view of an interface mechanism, in accordance with an embodiment of the invention;

FIG. 3C illustrates a perspective view of an endcap, in accordance with an embodiment of the invention;

FIG. 4 illustrates a cross-sectional perspective view of a water filter cartridge, in accordance with an embodiment of the invention;

FIG. 5A illustrates a perspective view of an interface mechanism, in accordance with an embodiment of the invention;

FIG. 5B illustrates a perspective view of an interface mechanism, in accordance with an embodiment of the invention;

FIG. 6 illustrates a side view of a water filter cartridge including a head, in accordance with an embodiment of the invention;

FIG. 7 illustrates a side view of a water filter cartridge including a head, in accordance with an embodiment of the invention;

FIG. 8 illustrates a partial cross-sectional view of a water filter cartridge including a head, in accordance with an embodiment of the invention;

FIG. 9 illustrates a perspective view of a water filter cartridge including a head, in accordance with an embodiment of the invention;

FIG. 9A illustrates a perspective view of a head, in accordance with the embodiment of FIG. 9;

FIG. 9B illustrates a perspective view of a head, in accordance with an embodiment of FIG. 9;

FIG. 10 illustrates a partial cross-sectional view of a water filter cartridge including a head, in accordance with an embodiment of the invention;

FIG. 10A illustrates a perspective view of a head, in accordance with the embodiment of FIG. 10;

FIG. 10B illustrates a perspective view of a head, in accordance with the embodiment of FIG. 10;

FIG. 11A illustrates a rear view of a head, in accordance with an embodiment of the invention;

FIG. 11B illustrates a side view of a head, in accordance with an embodiment of the invention;

FIG. 11C illustrates a top plan view of a head, in accordance with an embodiment of the invention;

FIG. 11D illustrates a top plan view of a head, in accordance with an embodiment of the invention;

FIG. 12A illustrates a perspective view of a head, in accordance with an embodiment of the invention;

FIG. 12B illustrates a perspective view of a head, in accordance with an embodiment of the invention;

FIG. 12C illustrates a cross-sectional view of a head, in accordance with an embodiment of the invention;

FIG. 13 illustrates a perspective view of a water filter cartridge including a head, in accordance with an embodiment of the invention;

FIG. 13A illustrates a cross-sectional view, in accordance with the embodiment of FIG. 13;

FIG. 13B illustrates a side view of a water filter cartridge including a head, in accordance with an embodiment of the invention;

FIG. 14 illustrates a side view of a water filter cartridge including a head, in accordance with an embodiment of the invention;

FIG. 14A illustrates a side view of the head, in accordance with the embodiment of FIG. 14;

FIG. 14B illustrates another side view of the head, in accordance with the embodiment of FIG. 14;

FIG. 15 illustrates a perspective view of a head, in accordance with an embodiment of the invention;

FIG. 16 illustrates a perspective view of a head, in accordance with the embodiment of FIG. 15;

FIG. 16B illustrates a perspective view of a head, in accordance with an embodiment of the invention;

FIG. 17 illustrates a perspective view of a head, in accordance with an embodiment of the invention;

FIG. 18 illustrates a perspective view of a head, in accordance with an embodiment of the invention;

FIG. 19 illustrates a perspective view of a head, in accordance with an embodiment of the invention;

FIG. 20 illustrates a perspective view of a head, in accordance with an embodiment of the invention;

FIG. 21 illustrates a perspective view of a head, in accordance with an embodiment of the invention;

FIG. 22 illustrates a perspective view of a head, in accordance with an embodiment of the invention;

FIG. 23 illustrates a perspective view of a head, in accordance with an embodiment of the invention;

FIG. 24 illustrates a perspective view of a head, in accordance with an embodiment of the invention;

FIG. 25 illustrates an exploded view of a water filter cartridge, in accordance with an embodiment of the invention;

FIG. 26 illustrates a perspective view of a head, in accordance with an embodiment of the invention;

FIG. 27 illustrates a perspective view of a head, in accordance with an embodiment of the invention;

FIG. 28 illustrates a perspective view of a water filter cartridge, in accordance with an embodiment of the invention;

FIG. 29 illustrates cross-sectional perspective view of a water filter cartridge, in accordance with an embodiment of the invention;

FIG. 30 illustrates a perspective view of a water filter cartridge, in accordance with an embodiment of the invention;

FIG. 31 illustrates a perspective view of a spring, in accordance with an embodiment of the invention;

FIG. 32 illustrates a perspective view of a water filter cartridge, in accordance with an embodiment of the invention;

FIG. 33 illustrates a perspective view of a head, in accordance with an embodiment of the invention;

FIG. 34 illustrates a perspective view of a head, in accordance with the embodiment of FIG. 33;

FIG. 35 illustrates a perspective view of a head, in accordance with the embodiment of FIG. 33;

FIG. 36 illustrates a front view of a head, in accordance with the embodiment of FIG. 33;

FIG. 37 illustrates perspective views of a pre-form for a water filter cartridge and a resulting thin-walled water filter cartridge, in accordance with an embodiment of the invention; and

FIG. 38 illustrates a forming process of a pre-form for a water filter cartridge and a resulting thin-walled water filter cartridge, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout. Where possible, any of the advantages, features, functions, devices, and/or operational aspects of any of the embodiments of the present invention described and/or contemplated herein may be included in any of the other embodiments of the present invention described and/or contemplated herein, and/or vice versa.

As used herein, “operatively coupled” may mean that the components may be formed integrally with each other or may be formed separately and coupled together. Furthermore, “operatively coupled” may mean that the components may be formed directly to each other or to each other with one or more components located between the components that are operatively coupled together. Additionally, or alternatively, “operatively coupled” may mean that the components are detachable from each other or that they are permanently coupled together. Furthermore, “operatively coupled” components may mean that the components retain at least some freedom of movement in one or more directions or may be rotated about an axis (i.e., rotationally coupled, pivotally coupled, and/or the like).

As noted, appliances, such as refrigerators, freezers, and/or the like, may include one or more components, such as a water dispenser, an ice maker, and/or the like, which use water from a water supply (e.g., a household water supply and/or the like). Such appliances typically include a water filter that filters water received from the water supply before the water is provided to the one or more components. Appliances typically include an opening to permit a user to remove an expired water filter and install a replacement water filter. However, such water filters typically remove chemicals, such as chlorine, from the household water supply that inhibit bacterial growth and eliminate microbial pathogens. Thus, the components to which the filtered water is provided, such as one or more water lines, fittings, or other plumbing mechanisms are in constant or frequent contact with water that no longer includes such chemicals. Contaminants in the water may be deposited on these components over time, allowing for the unintended growth of bacteria or microbial pathogens to occur within the components. User access to the internal cavities of these components is limited, and as such the present invention embraces a cartridge and method for cleaning water lines of an appliance.

Water filters, such as those described herein, allow access to the internal components of the water filter so that a user can replace the filtration media, and thereafter reuse the remaining components of the water filter. However, prior to replacing the filtration media, the cavity of the water filter cartridge may receive a cleaning media structured to clean and remove the bacteria or microbial pathogens within the components of the appliance. Upon receiving a command to cycle fluid through the appliance, the fluid is received by the water filter cartridge through the fluid inlet. Thereafter, the fluid mixes with the cleaning media inside the cavity of the water filter cartridge or cartridge, and subsequently exits as a liquid solution (e.g., a cleaning fluid) through the fluid outlet of the water filter cartridge or cartridge. Upon contacting the components of the appliance, such as one or more water lines, fittings, or the like, the cleaning media neutralizes and removes at least a portion of the bacteria and/or other microbial pathogens. While reference may be made to “water lines” throughout the present disclosure, it shall be appreciated that the liquid solution containing the cleaning chemical not only reduces mold and bacteria in the water lines, but also various other wetted components in fluid communication with the water lines. Such components may include, but are not limited to, water storage tanks, valves, connectors, pumps, or the like.

As used herein, a “liquid solution” may refer to a solution containing a cleaning chemical, wherein the solution is at a first concentration as it enters the appliance. As used herein, a “cleaning fluid” may refer to a solution containing a cleaning chemical, wherein the solution is at a second concentration, the second concentration of the “cleaning fluid” being less than the first concentration of the “liquid solution”. Such “cleaning fluid” may refer to the solution throughout the water lines and other wetted components. For example, as the cleaning process described herein begins, an initial solution will exit the container or filter housing at the first “full” concentration, which is herein is referred to as the liquid solution. However, it shall be appreciated that as more water (or other solvent) is introduced into the container or filter housing, the solution continues to be diluted at a varying rate. As such, the concentration of the resulting “cleaning fluid” throughout the water lines and other wetted components may be less than that of the “liquid solution.”

In one aspect, the present invention embraces a cartridge for cleaning water lines of an appliance. The cartridge may include a housing with a cavity, and a fluid inlet and a fluid outlet positioned on the housing and in fluid communication with the cavity. The fluid inlet and the fluid outlet may be configured to interface with a water filter cartridge manifold of an appliance, and a cleaning media disposed within the cavity.

The cartridge for cleaning water lines of an appliance may include additional embodiments, such as any single embodiment or any combination of embodiments described below and/or in connection with one or more other cartridges described elsewhere herein.

In a first embodiment, the housing may be a blow-molded housing.

In a second embodiment, alone or in combination with the first embodiment, the housing may be configured to provide access to the cavity.

In a third embodiment, alone or in combination with one or more of the first and second embodiments, a head may include the fluid inlet and the fluid outlet, wherein the head further includes a key extending radially outward from the head.

In a fourth embodiment, alone or in combination with one or more of the first through third embodiments, the head may include at least one displaceable latch feature extending longitudinally from the head.

In a fifth embodiment, alone or in combination with one or more of the first through fourth embodiments, the cleaning media may include a colorant.

In a sixth embodiment, alone or in combination with one or more of the first through fifth embodiments, the cleaning media oxidizes cell membranes of bacteria in one or more water lines of the appliance and reduces an intracellular pH of bacterial cells of the bacteria.

In a seventh embodiment, alone or in combination with one or more of the first through sixth embodiments, the cleaning media may be a liquid solution to be delivered through the water filter cartridge manifold to one or more water lines.

In a eighth embodiment, alone or in combination with one or more of the first through seventh embodiments, the cleaning media may be formulated to be diluted in water, while the fluid inlet and the fluid outlet interface with the water filter cartridge manifold, to form a liquid solution before delivery through the water filter cartridge manifold to one or more water lines.

In a ninth embodiment, alone or in combination with one or more of the first through eighth embodiments, the cleaning media may include at least one of a cleaning fluid, a concentrated cleaning fluid, or a solid concentrate.

In an tenth embodiment, alone or in combination with one or more of the first through ninth embodiments, dissolving the solid concentrate forms the cleaning fluid.

In a eleventh embodiment, alone or in combination with one or more of the first through tenth embodiments, dissolving the solid concentrate forms a liquid solution.

In a twelfth embodiment, alone or in combination with one or more of the first through eleventh embodiments, the liquid solution may have a concentration of between about 2 percent and 4 percent of a cleaning chemical.

In an thirteenth embodiment, alone or in combination with one or more of the first through twelfth embodiments, the liquid solution may include peracetic acid.

In a fourteenth embodiment, alone or in combination with one or more of the first through thirteenth embodiments, the liquid solution may have a concentration of about 5 percent or less of peracetic acid.

In a fifteenth embodiment, alone or in combination with one or more of the first through fourteenth embodiments, the liquid solution may have a concentration of between about 3 percent and 4 percent of peracetic acid.

In a sixteenth embodiment, alone or in combination with one or more of the first through fifteenth embodiments, the liquid solution may have a concentration of a cleaning chemical of at least about 0.01 percent throughout a whole length of the one or more water lines.

In a seventeenth embodiment, alone or in combination with one or more of the first through sixteenth embodiments, the liquid solution may be in the one or more water lines, the liquid solution may have a concentration of a cleaning chemical of at least about 0.25 percent throughout a whole length of the one or more water lines.

In a eighteenth embodiment, alone or in combination with one or more of the first through seventeenth embodiments, the one or more water lines of the appliance have a total length, and the cleaning media may be formulated such that the liquid solution may have sufficient concentration of the cleaning media through the total length of the one or more water lines to reduce a bacterial count in the one or more water lines of the appliance.

In a nineteenth embodiment, alone or in combination with one or more of the first through eighteenth embodiments, the one or more water lines of the appliance have a total length, and the cleaning media may be formulated such that the liquid solution may have sufficient concentration of the cleaning media through the total length of the one or more water lines to substantially eliminate bacteria in the one or more water lines of the appliance after the liquid solution may be positioned within the one or more water lines for at least a predetermined period of time.

In an twentieth embodiment, alone or in combination with one or more of the first through nineteenth embodiments, the cleaning media reduces mold at ends of the one or more water lines of the appliance.

In a twenty-first embodiment, alone or in combination with one or more of the first through twentieth embodiments, the cleaning media substantially eliminates bacteria in the one or more water lines of the appliance.

In another aspect, the present invention embraces a method for manufacturing a cartridge. The method may include molding a pre-form. The pre-form may include a head including a fluid inlet, a fluid outlet, and a cavity in fluid communication with the head.

The method may then include heating the pre-form to a predetermined temperature, inserting the pre-form into a molding chamber including mold pieces, inserting an injection device into the cavity, and supplying a pressurized gas to the injection device until the cavity expands to the mold pieces.

The method for manufacturing a cartridge may include additional embodiments, such as any single embodiment or any combination of embodiments described below and/or in connection with one or more other methods described elsewhere herein.

In a first embodiment, the method may further include filling the cavity with a cleaning media, and sealing the fluid inlet and the fluid outlet.

In a second embodiment, alone or in combination with the first embodiment, the head may include a key extending radially outward from the head.

In a third embodiment, alone or in combination with one or more of the first through second embodiments, the head may include at least one displaceable latch feature extending longitudinally from the head.

In yet another aspect, the present invention embraces a cleaning media. The cleaning media is formulated to be combined with water to form a liquid solution for delivery through a water filter cartridge manifold of an appliance to one or more water lines of the appliance. The cleaning media in the liquid solution reduces a bacterial count in the one or more water lines of the appliance.

The cleaning media may include additional embodiments, such as any single embodiment or any combination of embodiments described below and/or in connection with one or more other cleaning media described elsewhere herein.

In a first embodiment, the cleaning media in the liquid solution reduces mold at ends of the one or more water lines.

In a second embodiment, alone or in combination with the first embodiment, the cleaning media may be a solid formulated to be dissolved in water from the water filter cartridge manifold to form the liquid solution before delivery through the water filter cartridge manifold to the one or more water lines.

In a third embodiment, alone or in combination with one or more of the first and second embodiments, the cleaning media may be a liquid formulated to be diluted in water to form the liquid solution.

In a fourth embodiment, alone or in combination with one or more of the first through third embodiments, the cleaning media may be the liquid solution.

In a fifth embodiment, alone or in combination with one or more of the first through fourth embodiments, the cleaning media may be a liquid formulated to be diluted in water within the water filter cartridge manifold to form the liquid solution before delivery through the water filter cartridge manifold to the one or more water lines.

In a sixth embodiment, alone or in combination with one or more of the first through fifth embodiments, the cleaning media may be formulated such that, before delivery through the water filter cartridge manifold to the one or more water lines, the liquid solution may have a concentration of between about 2 percent and 4 percent of a cleaning chemical.

In a seventh embodiment, alone or in combination with one or more of the first through sixth embodiments, the liquid solution may include peracetic acid.

In an eight embodiment, alone or in combination with one or more of the first through seventh embodiments, the liquid solution may have a concentration of about 5 percent or less of peracetic acid.

In a ninth embodiment, alone or in combination with one or more of the first through eighth embodiments, the liquid solution may have a concentration of between about 3 percent and 4 percent of peracetic acid.

In a tenth embodiment, alone or in combination with one or more of the first through ninth embodiments, the cleaning media may be formulated such that, when the liquid solution may be in the one or more water lines, the liquid solution may have a concentration of a cleaning chemical of at least about 0.01 percent throughout a whole length of the one or more water lines.

In an eleventh embodiment, alone or in combination with one or more of the first through tenth embodiments, the cleaning media may be formulated such that, when the liquid solution may be in the one or more water lines, the liquid solution may have a concentration of a cleaning chemical of at least about 0.25 percent throughout a whole length of the one or more water lines.

In a twelfth embodiment, alone or in combination with one or more of the first through eleventh embodiments, the cleaning media in the liquid solution substantially eliminates bacteria in the one or more water lines of the appliance.

In a thirteenth embodiment, alone or in combination with one or more of the first through twelfth embodiments, the liquid solution may be formulated to substantially eliminate bacteria in the one or more water lines of the appliance after the liquid solution may be positioned within the one or more water lines for a predetermined amount of time.

In a fourteenth embodiment, alone or in combination with one or more of the first through thirteenth embodiments, the cleaning media in the liquid solution substantially eliminates bacteria in the one or more water lines of the appliance after the liquid solution may be positioned within the one or more water lines for a predetermined amount of time.

In a fifteenth embodiment, alone or in combination with one or more of the first through fourteenth embodiments, the one or more water lines of the appliance have a total length, and the cleaning media may be formulated such that the liquid solution may have sufficient concentration of the cleaning media through the total length of the one or more water lines to reduce the bacterial count in the one or more water lines of the appliance.

In a sixteenth embodiment, alone or in combination with one or more of the first through fifteenth embodiments, the one or more water lines of the appliance have a total length, and the cleaning media may be formulated such that the liquid solution may have sufficient concentration of the cleaning media through the total length of the one or more water lines to substantially eliminate bacteria in the one or more water lines of the appliance after the liquid solution may be positioned within the one or more water lines for at least a predetermined period of time.

In a seventeenth embodiment, alone or in combination with one or more of the first through sixteenth embodiments, the cleaning media may be formulated such that the liquid solution may include a mixture of acetic acid and hydrogen peroxide.

In an eighteenth embodiment, alone or in combination with one or more of the first through seventeenth embodiments, the cleaning media may be formulated such that the liquid solution may have a concentration of about 5 percent or less of peracetic acid.

In a nineteenth embodiment, alone or in combination with one or more of the first through eighteenth embodiments, the cleaning media may be formulated such that the liquid solution may have a concentration of between about 3 percent and 4 percent of peracetic acid.

In a twentieth embodiment, alone or in combination with one or more of the first through nineteenth embodiments, the cleaning media may include a colorant.

In a twenty-first embodiment, alone or in combination with one or more of the first through twentieth embodiments, the cleaning media oxidizes cell membranes of bacteria in the one or more water lines of the appliance and reduces an intracellular pH of bacterial cells of the bacteria.

In yet another aspect, the present invention embraces a method for cleaning water lines of an appliance. The method may include introducing cleaning fluid from a source into water lines of an appliance. This source may include a container of the cleaning fluid, and the container may be attached to a water filter cartridge manifold of the appliance. The method may further include, after introducing the cleaning fluid from the source, waiting at least a predetermined period of time, and after waiting at least the predetermined period of time, introducing water into the water lines to push the cleaning fluid out of the water lines.

The method for cleaning water lines of an appliance may include additional embodiments, such as any single embodiment or any combination of embodiments described below and/or in connection with one or more other methods described elsewhere herein.

In a first embodiment, the method may further include introducing additional water into the water lines to rinse the water lines.

In a second embodiment, alone or in combination with the first embodiment, the cleaning fluid may include a cleaning chemical.

In a third embodiment, alone or in combination with one or more of the first and second embodiments, the cleaning fluid may have a concentration of the cleaning chemical of at least about 0.25 percent throughout a whole length of the one or more water lines.

In a fourth embodiment, alone or in combination with one or more of the first through third embodiments, the cleaning fluid may have a concentration of the cleaning chemical of at least about 0.01 percent throughout a whole length of the one or more water lines.

In a fifth embodiment, alone or in combination with one or more of the first through fourth embodiments, introducing cleaning fluid from the source into the water lines of the appliance may include introducing cleaning fluid from the source to substantially fill one or more of the water lines of the appliance.

In a sixth embodiment, alone or in combination with one or more of the first through fifth embodiments, the container may include concentrate, and the method may include, before introducing the cleaning fluid from the source into the water lines of the appliance, introducing water into the container to dilute the concentrate to form the cleaning fluid.

In a seventh embodiment, alone or in combination with one or more of the first through sixth embodiments, the container may include solid concentrate, and the method may include, before introducing the cleaning fluid from the source into the water lines of the appliance, introducing water into the container to dissolve the solid concentrate to form the cleaning fluid.

In an eighth embodiment, alone or in combination with one or more of the first through seventh embodiments, the appliance may be a refrigerator.

In a ninth embodiment, alone or in combination with one or more of the first through eight embodiments, the method may include providing the container, wherein the container comprises the cartridge of any one of the preceding embodiments.

In a tenth embodiment, alone or in combination with one or more of the first through the ninth embodiments, the head of the cartridge may include a key extending radially outward from the head.

In a eleventh embodiment, alone or in combination with one or more of the first through tenth embodiments, the head of the cartridge may include at least one displaceable latch feature extending longitudinally from the head.

In yet another aspect, the present invention embraces a method for cleaning water lines of an appliance. The method may include causing an appliance to introduce cleaning fluid from a container into one or more water lines of the appliance. The container may be attached to a water filter cartridge manifold of the appliance. The method may then include, after introducing the cleaning fluid from the container, waiting at least a predetermined period of time. After waiting at least the predetermined period of time, the method may include causing the appliance to introduce water into the water lines to push the cleaning fluid out of the water lines.

The method for cleaning water lines of an appliance may include additional embodiments, such as any single embodiment or any combination of embodiments described below and/or in connection with one or more other methods described elsewhere herein.

In a first embodiment, the appliance may be a refrigerator.

In a second embodiment, alone or in combination with the first embodiment, the method may include, before causing the appliance to introduce the cleaning fluid from the container, positioning the container such that it may be in fluid communication with the water filter cartridge manifold of the appliance.

In a third embodiment, alone or in combination with one or more of the first and second embodiments, causing the appliance to introduce the cleaning fluid from the container may include causing the appliance to introduce the cleaning fluid from the container to substantially fill the one or more of the water lines of the appliance.

In a fourth embodiment, alone or in combination with one or more of the first through third embodiments, causing the appliance to introduce water into the water lines may include, after introducing the cleaning fluid from the container, replacing the container with a water filter cartridge.

In a fifth embodiment, alone or in combination with one or more of the first through fourth embodiments, the method may include providing the container, and the container may include the cartridge of any one of the preceding embodiments.

In a sixth embodiment, alone or in combination with one or more of the first through fifth embodiments, the container may include the cartridge of any one of the preceding embodiments, and the method may include, prior to introducing the cleaning fluid from the container, manipulating the housing to obtain access to the removable filtration media, removing the removable filtration media from the cavity, positioning the cleaning fluid in the cavity, and manipulating the housing to close the cavity.

In a seventh embodiment, alone or in combination with one or more of the first through sixth embodiments, the method may include, before causing the appliance to introduce the cleaning fluid from the container, causing the appliance to introduce water into the container to dilute a concentrate to form the cleaning fluid.

In an eighth embodiment, alone or in combination with one or more of the first through seventh embodiments, the method may include, before causing the appliance to introduce the cleaning fluid from the container, causing the appliance to introduce water into the container to dissolve a solid concentrate to form the cleaning fluid.

In a ninth embodiment, alone or in combination with one or more of the first through eighth embodiments, the method may include prior to introducing the cleaning fluid from the container, removing the container from the appliance, and, after manipulating the housing to close the cavity, inserting the container into the appliance and engaging the fluid inlet and the fluid outlet with the water filter cartridge manifold of the appliance.

In a tenth embodiment, alone or in combination with one or more of the first through ninth embodiments, the method may include, after introducing the cleaning fluid from the container, manipulating the housing to obtain access to the cavity within the housing, rinsing the container to remove residual cleaning fluid from the container, inserting the removable filtration media or another removable filtration media into the cavity, and manipulating the housing to close the cavity.

In an eleventh embodiment, alone or in combination with one or more of the first through tenth embodiments, the method may include, before manipulating the housing to obtain the access to the cavity within the housing, removing the container from the appliance, and, after manipulating the housing to close the cavity, inserting the container into the appliance and engaging the fluid inlet and the fluid outlet with the water filter cartridge manifold of the appliance.

In yet another aspect, the present invention embraces an appliance. The appliance may include a water filter cartridge manifold configured to receive a water filter cartridge. The appliance may also include one or more water lines in fluid communication with the water filter cartridge manifold. The appliance may also include at least one processing device, and at least one non-transitory storage device including computer-executable program code that, when executed by the at least one processing device, causes the at least one processing device to introduce, through the water filter cartridge manifold, cleaning fluid from a source into the one or more water lines. Then, after introducing the cleaning fluid from the source, wait at least a predetermined period of time, and after waiting at least the predetermined period of time, introduce, through the water filter cartridge manifold, water into the one or more water lines to push the cleaning fluid out of the one or more water lines.

The appliance may include additional embodiments, such as any single embodiment or any combination of embodiments described below and/or in connection with one or more other appliances described elsewhere herein.

In a first embodiment, the water filter cartridge may include the cartridge of any one of the preceding embodiments.

In a second embodiment, alone or in combination with the first embodiment, the appliance may be a refrigerator.

In a third embodiment, alone or in combination with one or more of the first through the second embodiments, the head of the cartridge may include a key extending radially outward from the head.

In a fourth embodiment, alone or in combination with one or more of the first through third embodiments, the head of the cartridge may include at least one displaceable latch feature extending longitudinally from the head.

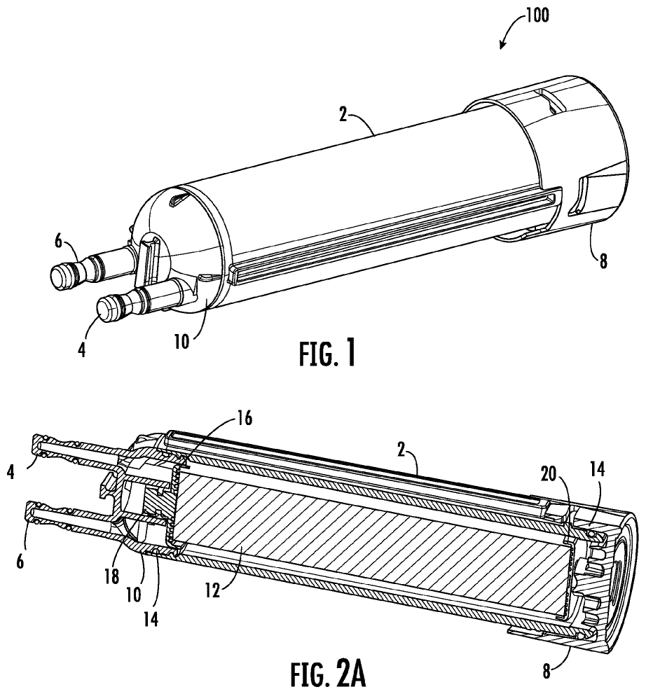

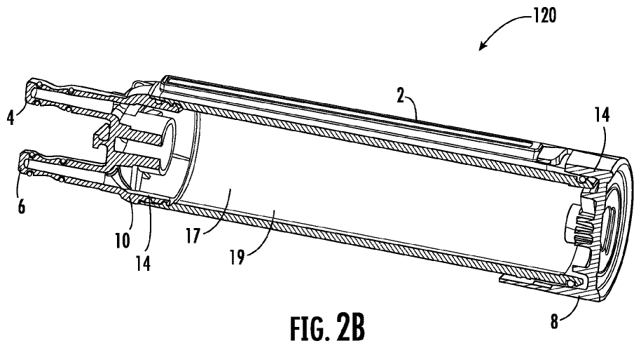

FIGS. 1 and 2A illustrate a perspective view and a cross-sectional perspective view, respectively, of a water filter cartridge 100, in accordance with an embodiment of the invention. As shown in FIG. 1, the water filter cartridge 100 includes a filter housing 2 defining a cavity. Filter housing 2 is substantially hollow and cylindrical in shape, with a substantially tubular void therein. Additionally, or alternatively, the filter housing 2 may be slightly conical such that the first end has a smaller radius than the radius of the second end. The filter housing 2 defines a first end and a second end, and a longitudinal axis therebetween.

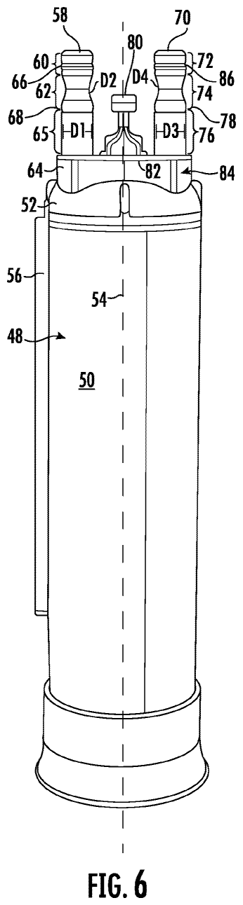

In some embodiments, positioned on the first end may be a fluid inlet 4 and a fluid outlet 6. The fluid inlet 4 and fluid outlet 6 may be configured to be in fluid communication with the cavity of the filter housing 2, in order to transport a fluid such as water or the liquid solution. The fluid inlet 4 and the fluid outlet 6 may be coupled to a head 10, which may, in some embodiments, be separable from the filter housing 2. Head 10 may also comprise one or more snap features structured to matingly engage with one or more snap receptacles on the inner or outer surfaces of the filter housing 2. Various embodiments of head 10 are contemplated herein, in order to interface with a manifold of a range of appliances, and such embodiments will be described with greater detail herein in FIGS. 6-38.

In some embodiments, positioned on the second end of the filter housing 2 may be a removable portion such as a cap 8, the cap 8 structured to be removably coupled to the filter housing 2 to provide access to the cavity of the filter housing 2. The cap 8 may be comprised of one or more apertures, the apertures structured to receive one or more corresponding protuberances on the outer surface of the filter housing 2, such that the cap 8 is held in place securely. Likewise, in some embodiments, cap 8 may comprise one or more snap features structured to matingly engage with one or more snap receptacles on the inner or outer surfaces of the filter housing 2.

Water filter cartridge 100 may also comprise one or more seals 14, at least one of the seals 14 positioned between cap 8 and the outer surface of the filter housing 2, and at least one of the seals 14 positioned between head 10 and the filter housing 2. The seals 14 are compressed by material interference between the filter housing 2, the seals 14, and either the head 10 or cap 8, such that fluid is prevented from leaking between any gaps between adjacent surfaces of the cap 8 or the head 10 and the filter housing 2. In the embodiment depicted in FIG. 2A, the seal 14 between the head 10 and the filter housing 2 is shown as being substantially similar in size to the seal 14 between the cap 8 and the filter housing 2. It shall be understood that in some embodiments, seals 14 may be sized differently from one another, such as to accommodate various sizes of cap 8, head 10, and filter housing 2.

By removing the cap 8, a user may have access to the removable filtration media 12. Filtration media 12 may be comprised of any number of compounds, elements, or chemicals structured to remove, filter, or otherwise neutralize contaminants or objects from the fluid once the fluid enters the fluid inlet 6 and passes through the filtration media 12.

Examples include, but are not limited to: carbon, sediment, reverse osmosis filter, deionizing filters, or the like. The filtration media 12 may be defined by a first end and a second end, and may be substantially cylindrical in shape. In some embodiments, the filtration media 12 may also comprise an aperture extending from the first end towards the second end, such as to form a cavity within the filtration media 12.

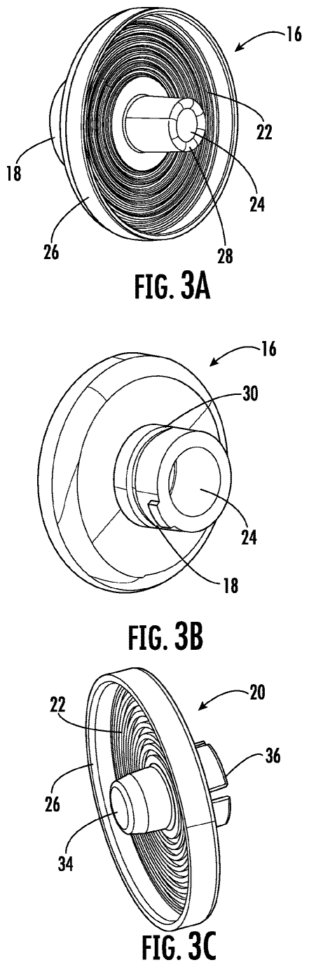

Still referring to FIG. 2A, adjacent the first end of the filtration media 12 is the interface mechanism 16, structured to receive fluid after the fluid has interacted with the filtration media 12, and thereafter direct the fluid through a first protuberance 18 and to the fluid outlet 4. Various embodiments of interface mechanisms 16 and 38 will be described in greater detail hereinafter with reference to FIGS. 3A-3B and 5A-5B. Adjacent the second end of the filtration media 12 is the endcap 20.

After the water filter cartridge 100 has been positioned within a manifold of an appliance, the fluid inlet 4 and the fluid outlet 6 of the head 10 may be in fluid communication with the manifold. Accordingly, the water filter cartridge 100 may receive unfiltered water through a fluid passageway of the manifold, which is in fluid communication with the fluid inlet 4. After passing through the water filter cartridge 100, the filtered water exits the water filter cartridge 100 through the fluid outlet 6 and enters a corresponding fluid passageway of the manifold.

It shall be understood that in some embodiments, a filtration cartridge may be provided, the filtration cartridge having a filtration media 12, the interface mechanism 16 adjacent the first end of the filtration media 12, and an endcap 20. In this way, a user may remove the existing filtration cartridge from the water filter cartridge 100 and replace it with another filtration cartridge after the cleaning media has been added to the existing filtration cartridge and the cleaning process has been completed.

Prior to a user replacing the filtration cartridge, in an operation where the user wishes to clean the one or more water lines or other components of the appliance, the user may remove either the cap 8 or head 10, and supply the cavity of the filter housing 2 with the cleaning media 19. The user may then re-install the cap 8 or the head 10 and position the water filter cartridge 100 in the manifold, such that the water filter cartridge 100 is configured to receive incoming water from the appliance or another pressurized water source.

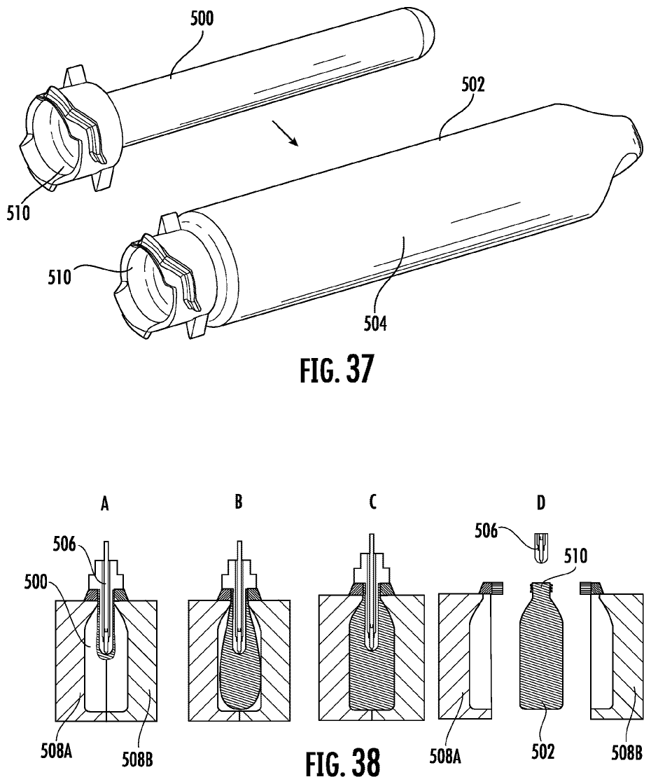

Additionally, or alternatively, the user may, after removing the existing filtration cartridge from the water filter cartridge 100, introduce cleaning fluid and/or a liquid solution (e.g., including the cleaning media) from a source by placing the source in fluid communication with the manifold of the appliance. In this regard, containers and/or systems other than the water filter cartridge 100 may be a source for cleaning fluid, liquid solution, cleaning media, and/or the like. That said, in some embodiments, the water filter cartridge 100 and/or a similar device may be the source for cleaning fluid, liquid solution, cleaning media, and/or the like. For example, in some embodiments such as that which will be described herein with respect to at least FIGS. 37 and 38, the water filter cartridge 100 may be pre-loaded with the cleaning fluid, liquid solution, or cleaning media, such that an end user need only remove an existing water filter cartridge, and insert the water filter cartridge 100 described herein to prepare for the cleaning and disinfecting of one or more water lines of the appliance or other wetted components in fluid communication with the one or more water lines.

The cleaning media 19 may comprise a cleaning chemical, peracetic acid (“PA”), to clean and disinfect the one or more water lines of the appliance, or other wetted components with which it contacts. The cleaning chemical may be formed using a mixture of acetic acid and hydrogen peroxide or by other methods. The peracetic acid neutralizes bacteria or other microbial pathogens by damaging, via an oxidation reaction, the cell membranes of the bacteria or other microbial pathogens. Thereafter, the peracetic acid penetrates the damaged cell membrane of the bacteria or other microbial pathogens and reduces the intracellular pH to a level at which the cell(s) of the bacteria or other microbial pathogens no longer functions.

In some embodiments, the cleaning media 19 may be a concentrated liquid solution of peracetic acid, such that no water or other solvent is added to the cleaning media 19 prior to the water filter cartridge 100 receiving the cleaning media 19. However, in other embodiments, the cleaning media 19 may be liquid peracetic acid diluted to a liquid solution of at least 2.5 parts peracetic acid per one thousand (1,000) parts water (a 0.25% dilution). Since water continuously flows into the cavity of the filter housing 2 during operation, thereby further diluting the peracetic acid solution, a concentration between 2 percent dilution and 4 percent dilution of the cleaning media 19 is preferred, preferably 35 parts peracetic acid per 1000 parts water (a 3.5% dilution). The cleaning media 19 in a concentrated solution between 2 percent and 4 percent dilution will subsequently be lowered to between about 0.01 percent and 0.3 percent throughout a whole length of the one or more water lines when diluted by water from the water filter cartridge manifold. In this way, a liquid concentration of the cleaning media 19 before delivery through the water filter cartridge manifold to the one or more water lines (or other wetted components in fluid communication with the one or more water lines) is higher than that which is present in the one or more water lines.

To provide effective removal or neutralization of the bacteria or other microbial pathogens, the peracetic acid diluted in water to form the liquid solution should be positioned within the one or more water lines, or other wetted components in fluid communication with the one or more water lines, for a predetermined amount of time between 30 seconds and 4 minutes, preferably two minutes.

In some embodiments, the cleaning media 19 may be provided as a liquid solution, such that the user supplies the liquid solution to the cavity of the filter housing 2. In another embodiment, the cleaning media 19 may be provided in one or more pre-measured pods, the cleaning media 19 in each pod is surrounded by a solid dissolvable layer structured to dissolve upon contact with water inside of the cavity of the filter housing 2, thereafter exposing the cleaning media 19 to the water inside of the cavity. In yet additional embodiments, the cleaning media 19 may be structured as a concentrated solid (a) granular powder, (b) granular powder pressed into pre-measured shapes, or (c) granular powder provided in one or more pre-measured pods, the cleaning media 19 in each pod surrounded by a solid dissolvable layer structured to dissolve upon contact with water inside of the cavity of the filter housing 2, thereafter exposing the cleaning media 19 to the water inside of the cavity.

In some embodiments, the cleaning media 19 may include a pigment. The pigment may be a food-safe colorant added to the cleaning media 19 to provide a visual indication that the fluid exiting the appliance contains the cleaning media. As one non-limiting example, the cleaning media 19 may include a blue pigment. However, any other colors of the pigment may be suitable for use in the cleaning media 19.

To perform cleaning of the water lines of an appliance, or other wetted components in fluid communication with the one or more water lines, a user may approach an appliance and introduce the cleaning fluid (e.g., liquid solution) through one or more water lines of the appliance by inserting the water filter cartridge comprising the cleaning media 19 into the water filter cartridge manifold. The introduction of the cleaning fluid (e.g., liquid solution) occurs via the user interacting with the appliance, for example by pressing a lever or button, to remove water from the water lines and allow for the liquid solution to fill the water lines. The entirety of the water lines of the appliance, as well as various other wetted components in fluid communication with the water lines, will be filled with the liquid solution once the user outlet (for example, the beverage ice and water dispensing portion of the appliance) is presenting a colorized liquid, indicating the presence of the liquid solution as opposed to clear water. Thereafter, a predetermined amount of time passes prior to the replacement of the water filter cartridge to begin introduction of water into the one or more water lines of the appliance.

Referring now to FIG. 2B, FIG. 2B illustrates a cross-section perspective view of a cartridge 120 without a filtration cartridge. It shall be understood that some users of appliances may desire that their appliance not perform filtration of water, and as such, cartridge 120 is provided to the user to allow water to pass through the appliance without filtration provided by the appliance. Cartridge 120 may be similarly supplied with the cleaning media 19, either in a pre-configured cartridge 120 comprising cleaning media 19, or as a separate cleaning media 19 for implementation with a user's cartridge 120. It shall also be understood that any of the embodiments of water filter cartridges 100, 110 described herein may be configured as a cartridge 120 by not including the filtration cartridge. In this way, the head 10 may take any number of the embodiments as described herein.

As illustrated in FIG. 2B, the water filter cartridge 120 may include a fluid outlet 4, fluid inlet 6, seals 14, cap 8, filter housing 2, and head 10. Furthermore, the filter housing 2 defines a cavity 17, configured to receive the cleaning media 19 and water from the fluid inlet 6. In some embodiments, a user may provide the cleaning media 19 to the cavity 17, by removing either the cap 8 or the head 10. In other embodiments, a water filter cartridge 120 may be provided, pre-filled with cleaning media 19 in the cavity 17.

FIGS. 3A-3B illustrate perspective views of an interface mechanism 16, in accordance with an embodiment of the invention. Interface mechanism 16 is primarily disk-shaped, defining a first face and a second face. The second face of the interface mechanism 16 is structured with a plurality of grooves 22, the grooves 22 configured to be positioned adjacent the first end of the filtration media 12. Along the perimeter of interface mechanism 16 is a wall 26 extending from the first face, past the second face, the interior of which defines a cylindrical face structured to be adjacent the outer surface of the filtration media 12. The interface mechanism 16 also includes a first protuberance 18 extending from the first face of the interface mechanism 16 towards the head 10, the outer surface of the first protuberance 18 structured to matingly engage with a corresponding aperture of the head 10. Moreover, one or more seals 30 may be positioned adjacent the outer surface of the first protuberance 18 in order to sealingly engage the interface mechanism 16.

In an embodiment including the interface mechanism 16, the head 10 may be structured such that the corresponding aperture of head 10 is in fluid communication with the fluid outlet 4. The interface mechanism 16 also includes a second protuberance 28 extending from the second face of the interface mechanism 16 towards the filtration media 12, the outer surface of the second protuberance 28 structured to matingly engage with a corresponding aperture of the filtration media 12.

The first and second protuberances 18, 28, as shown in FIGS. 3A-3B, are positioned along the axis defining the filter housing 2. The first and second protuberance 18,28 may be sized similarly or dissimilarly relative one another, depending on the structures of the corresponding head 10 and filtration media 12. An aperture 24 extends between the first and second protuberances 18, 28 such that fluid, having already contacted the filtration media 12, may move from the filtration media 12, through the interface mechanism 16, and finally to the head 10 including the fluid outlet 4.

FIG. 3C illustrates a perspective view of an endcap 20, in accordance with an embodiment of the invention. Endcap 20 is primarily disk-shaped, defining a first face and a second face. The first face of the endcap 20 is structured with a plurality of grooves 22, the grooves 22 configured to be positioned adjacent the second end of the filtration media 12. Along the perimeter of endcap 20 is a wall 26 extending from the second face, past the first face, the interior of which defines a cylindrical face structured to be adjacent the outer surface of the filtration media 12. The endcap 20 also includes a protuberance 36 extending from the second face of the endcap 20 towards the cap 8, the outer surface of the protuberance 36 structured to matingly engage with a corresponding aperture of the cap 8.

The endcap 20 also includes a plug 34 extending from the first face of the endcap 20 towards the filtration media 12, the outer surface of the plug 34 structured to matingly engage with a corresponding aperture of the filtration media 12. Unlike the aperture 24 of the interface mechanism 38 in FIGS. 3A-3B, the outer surface of the plug 34 is continuous and no such aperture is present in the plug 34.

FIGS. 5A-5B illustrate perspective views of an interface mechanism 38, in accordance with an embodiment of the invention. Similar to the interface mechanism 16, the interface mechanism 38 of the present embodiment is primarily disk-shaped, defining a first face and a second face. The second face of the interface mechanism 38 is structured with a plurality of grooves 22, the grooves 22 configured to be positioned adjacent the first end of the filtration media 12. Along the perimeter of interface mechanism 38 is a wall 26 extending from the first face, past the second face, the interior of which defines a cylindrical face structured to be adjacent the outer surface of the filtration media 12. The interface mechanism 38 also includes a first protuberance 18 extending from the first face of the interface mechanism 38 towards the head 10.

Unlike the interface mechanism 16 described with respect to FIGS. 3A-3B, here the outer surface of the first protuberance 18 of the interface mechanism 38 is structured to matingly engage and be in fluid communication with a corresponding aperture of the fluid outlet 4. As such, the first protuberance 18 may be positioned off-center from the axis defining filter housing 2 in the event that the fluid outlet 4 is positioned off-center from the axis relative the filter housing 2. The first protuberance 18 defines a first aperture 46. Moreover, one or more seals 42 may be positioned adjacent the outer surface of the first protuberance 18 in order to sealingly engage the fluid outlet 4.

The interface mechanism 38 also includes a second protuberance 28 extending from the second face of the interface mechanism 38 towards the filtration media 12, the outer surface of the second protuberance 28 structured to matingly engage with a corresponding aperture of the filtration media 12. The second protuberance 28 defines a second aperture 24. The first and second protuberances 18, 28 may be sized similarly or dissimilarly relative one another, depending on the structures of the corresponding fluid outlet 4 and filtration media 12. The first and second apertures 24, 46 are in fluid communication with each other, defining a cross-over passage 44 therebetween. In this way, fluid having already contacted the filtration media 12 may move from the filtration media 12, through the cross-over passage 44 of the interface mechanism 38, and finally to the fluid outlet 4.

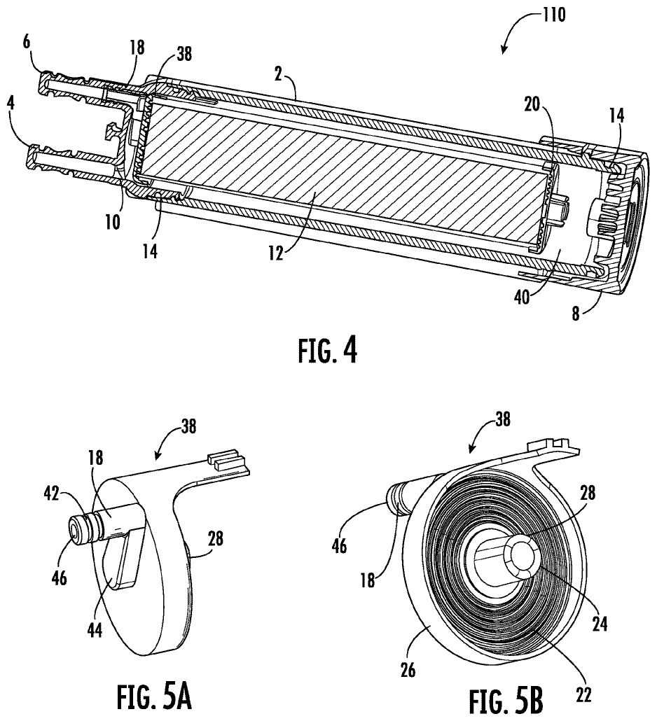

Referring now to FIG. 4, wherein another embodiment of a water filter cartridge 110 having interface mechanism 38 is exemplified in a cross-section view, it shall be appreciated that when interface mechanism 38 is configured as shown, the position of the filtration media 12 is in closer in proximity to head 10, thereby introducing a void 40 between the endcap 20 and the cap 8. As such, the length of filtration media 12 may be lengthened between the first end and the second end (not shown in FIG. 4), such as to fill the void 40. By increasing the distance between the first end and the second end of the filtration media 12, the filtration media 12 may be lengthened, thus increasing the surface area of the filtration media 12 in contact with the fluid. As such, the lifespan of the filtration media 12 may be increased, or in some embodiments such a lengthening of the filtration media 12 may results in the improvement of removal of contaminants or suspended articles in the fluid.

The foregoing embodiments and elements of the foregoing embodiments may be combined with one or more features, embodiments, examples, elements, and/or the like described hereinafter. For example, the foregoing embodiments of a water filter cartridge may include features and/or elements of the heads set forth in the following description.

FIG. 6 illustrates a side view of a water filter cartridge including a head, in accordance with an embodiment of the invention. As shown in FIG. 6, filter housing assembly, comprising a housing 48 with a substantially cylindrical body 50 and a top portion 52 for forming a fluid-tight seal with the body. A strengthening rib 56 runs along the length of the cylindrical body 50, parallel to a longitudinal axial center line 54. The top portion 52 is depicted as substantially dome-shaped to facilitate the filter housing assembly as a pressurized vessel; however, it may be a flat surface if design constraints require. The cylindrical body 50 and housing top portion 52 share the longitudinal axial center line 54. A protrusion extends in the axial direction upwards from top portion 52, and outwards in a radial direction about the axial center 54. Dimensionally, the protrusion extends upwards approximately 0.15-0.35 inches—and preferably 0.24 inches—from the top surface of the housing top portion 52. Housing 48 may hold a filtration media therein for the filtration of fluids, may act as a sump, or may act as a bypass filter cartridge having no filtration media. Housing 48 is further adapted to receive a connection assembly 84 which consists of an electronic circuit component and a housing 64 for receiving said electronic circuit component therein.

As shown in FIG. 6, an ingress port 58 is demarcated into three distinct segments: a first or top segment 60, a second or middle segment 62, and a third or bottom segment 65. The third or bottom segment 65 extends vertically upwards in a longitudinally axial direction from the surface of housing top portion 52 substantially parallel to the axial center line 54. The ingress port bottom segment 65 is separated from middle segment 62 by seal 68. The ingress port top segment 60 extends from the ingress port middle segment 62 upwards to the topmost surface of the port, and is separated from middle segment 62 by seal 66. Seals 66 and 68 prohibit fluid exiting ingress port middle segment's aperture or cavity a from contacting the outer surface of the ingress port top and bottom segments 60, 65, respectively, once the ingress port is inserted within a receiving filter base stanchion. Seals 66 and 68 provide a circumferential press-fit or sealing force against the inner cylindrical wall of the stanchions of the filter base (not shown). Seals 66, 68 are held in place on the ingress port typically by insertion into a groove within the ingress port cylindrical outer surface, such that a diameter D1 of the outermost seal radial extension is slightly greater than the inner wall diameter of the receiving stanchion, allowing the resilient, compressible seals to be compressed by the inner wall of the receiving stanchion upon insertion.

In at least one embodiment, ingress port middle segment 62 has a varying diameter D2 unequal to, and less than D1, such that the ingress port middle segment 62 is formed having an outer surface contour to allow for fluid to flow around the middle segment 62 after the ingress port 58 is inserted into its respective stanchion. Fluid exiting the filter base stanchion is contained by and between seals 66, 68 and the circumferential stanchion inner wall. The fluid traverses around the ingress port middle segment and enters the ingress port middle segment aperture or cavity.

In the embodiment depicted in FIG. 6, the outer surface contour of ingress middle segment 62 is depicted in the form of an hourglass shape having a smaller diameter at its center than at either the topmost or bottommost points of the middle segment closest to the seals 66, 68. The ingress port middle segment's body may be formed of other shapes as well, such as a smaller cylindrical shape having a diameter less than DI, a rectangular or triangular segment, or cone-shaped architecture, wherein the middle segment 62 has at least one area where its measured diameter is less than diameter DI, providing an annular space for fluid to flow around the middle segment structure to allow fluid, exiting the filter base input port into the stanchion to enter the ingress port middle segment's aperture or cavity.

Preferably, ingress port 58 is substantially cylindrical at its top and bottom segments to correspond to the cylindrical cavity of its respective receiving stanchion. The measurements of the outermost surface contour of ingress port 58 at the seals 66, 68/stanchion inner wall interface, which is identified by diameter D1, may be between 0.25-0.45 inches—and optionally 0.36 inches—while the ingress middle segment diameter D2 of ingress port 58 may be between 0.2-0.4 inches, and optionally 0.28 inches. The middle segment diameter D2 is less than diameter D1 and the diameter of the receiving stanchion to achieve fluid flow about and around the ingress port middle segment from the exit port of the stanchion on one side to the input aperture a of the middle segment to the other side. A fluid seal is still maintained during such instances of fluid flow, such that fluid is prohibited from contacting the outer surface of the ingress port top or bottom segments. This allows for the outer surface contour of ingress middle segment 62 to be less than, and within, the compressed sealing diameter DI at the filter base's stanchion inner wall.

An egress port 70 similarly having a substantially cylindrical body with a first or top segment 72, a second or middle segment 74, and a third or bottom segment 76, extends vertically upwards in a longitudinally axial direction from the top surface of housing top portion 52 substantially parallel to top portion axial center 54. The egress port top segment 72 extends from its topmost point downwards to the egress port middle segment 74, and is separated from middle segment 74 by a seal 78. The egress port bottom segment 76 extends from housing top portion 52 upwards to the egress port middle segment 74, and is separated from middle segment 74 by seal 86. Seals 86, 78 prohibit fluid exiting the egress port middle segment 74 aperture or cavity 640 b from contacting the outside surface of egress port top and bottom segments 72, 76, respectively. Seals 86, 78 provide a circumferential press-fit or sealing force against the inner cylindrical wall of the receiving stanchion of the filter base (not shown). Seals 86, 78 are held in place on the egress port typically by insertion within a groove on the egress port outer wall surface, such that a diameter D3 of the outermost seal radial extension is slightly greater than the inner wall diameter of the receiving stanchion allowing the resilient, compressible seals to be compressed by the inner wall of the receiving stanchion upon insertion. In a similar fashion as the ingress port, the egress port middle segment 74 may be formed in other shapes that allow fluid to flow around the middle segment when the middle segment is placed within the receiving filter base stanchion. In the embodiment depicted in FIG. 6, the outer surface contour of egress middle segment 74 is depicted in the form of an hourglass shape having a smaller diameter D4 at its center than at either the topmost or bottommost points of the middle segment closest the seals 86, 78. The egress port middle segment's body may be formed of other shapes as well, such as a smaller cylindrical shape having a diameter less than D3, a rectangular or triangular segment, or cone-shaped architecture, wherein the middle segment 74 has at least one area where the surface contour radial extension remains within the constraints of diameter D3 to allow fluid, exiting egress port middle segment's aperture or cavity and contained by seals 86, 78 and the circumferential stanchion inner wall, to flow around the egress port middle segment to the opposite side for input into the filter base from an aperture in the receiving stanchion.

The ingress port segments 60-65 and egress port segments 72-76 may each have outer surface contours separate and distinct from one other. In the alternative, ingress port segments 60-65 and egress port segments 72-76 may have substantially similar outer surface topologies. In any case, the respective middle segments will have an outer surface topology (e.g., the outer diameter in a substantially cylindrically shaped embodiment) that has an outer surface contour with a diameter or width that is less than the inner wall of the receiving filter base stanchion by an amount sufficient to create an annular gap that allows fluid to flow around and about the middle segments between their respective upper and lower seals.

The measurements of outermost diameter D3 of egress port 70 at the seal/stanchion inner wall interface may be between 0.25-0.45 inches—and optionally 0.36 inches—while the egress middle segment 74 diameter D4 of egress port 70 may be between 0.2-0.4 inches, and optionally 0.28 inches. The middle segment smaller radial extension D4 is less than diameter D3 to achieve fluid flow about and around the egress port middle segment. This allows for the outer surface contour radial extension of ingress middle segment 62 to be less than the compressed sealing diameter at the manifold's stanchion inner wall.

Ingress port 58 and egress port 70 both include aperture or cavity located on their respective middle segments 62, 74 for the passage of fluid. The ingress port and egress port apertures or cavities are exposed in a direction facing away from the filter base stanchion apertures that are in fluid communication with apertures. The opposing placement of the apertures is helpful because upon extraction of the filter cartridge, if ingress and egress apertures are in a direction facing the filter base stanchion apertures (defined simply as a means of convention as a forward direction), any fluid that drains from apertures may drip upon the electronics and electronic surfaces populated on the electronic circuit component or printed circuit board located forward of the filter key in a PCB housing 64. Once the filter housing 48 is installed in the filter base or manifold, the cavities of the ingress and egress ports are designed to be facing away from the filter base ports (not shown). Water flowing through housing assembly thus enters and exits the cavities, flows around the middle segments 62, 74 of the ingress and egress ports within the manifold stanchions, and continues into the ports. The variable radial extensions or diameters D2, D4 of the middle segments 62, 74, respectively, allows for the water to flow around the ingress and egress port middle segments within the stanchion's cylindrical cavity without building undue pressure that could otherwise force a leak through the seals 66, 68, 86, 78 and onto the filter housing assembly, which would otherwise cause damage to the electronics disposed on the printed circuit board as further described below.

Ingress port and egress port 58, 70 extend from, and are substantially perpendicular to, a non-diameter chord line C1 of the housing top portion 52. Moving the ingress and egress ports off a corresponding parallel diameter of the housing top portion is helpful to allow for sufficient space on the housing top portion 52 for placement of the PC board housing 64 and PC board. Dimensionally, the distance between chord line Cl and a parallel diameter of housing top portion 52 may be between 0.1-0.5 inches, and optionally 0.3 inches. The ingress and egress ports are off-diagonal center in order to accommodate the remaining particular features of the housing assembly. Ingress port 58 and egress port 70 are spaced apart from each other on chord line C1 by approximately 0.65-0.85 inches, and optionally 0.74 inches. The filter key 80 is centered on, and perpendicularly intersects with, chord line C1.

A “diameter” as used herein, may refer to a straight line passing through corresponding sides of the component/portion/segment, such as that of the port (ingress port 58 and/or egress port 70). Typically, the diameter is a straight line passing through opposite sides of the component/portion/segment, such as that of the port (ingress port 58 and/or egress port 70), e.g., in a plane perpendicular to the central axis of the water filter cartridge. Here, the length of the diameter is the perpendicular distance between the opposite sides of the component/portion/segment, e.g., in a plane perpendicular to the central axis. In some instances, the diameter line passes through a center, a centroid, a focus, a center of curvature, a circumcenter, and/or another center of a circular or non-circular cross-section of the component/portion/segment, such as that of the port (ingress port 58 and/or egress port 70) along the plane perpendicular to the central axis. In some instances, e.g., where the portion/segment of the port (ingress port 58 and/or egress port 70) comprises a circular or oval cross section, the diameter line may pass through a center and/or a focus of the cross section.

The filter key 80 structured for mating attachment to a filter base or manifold is located on or connected to the housing 48, and extends upwards in a direction parallel to the axial center 54 of the housing top portion 52. Filter key 80 comprises a base having a front lateral side 82a, and a rear or back lateral side 82b, with a groove running therethrough for receiving protrusion on housing top portion 52, and lengthwise or longitudinal sides running substantially parallel to protrusion. Filter key 80 is secured to the housing top portion 52 via the connection between groove and protrusion.

Base extends upward along the housing top portion axial center 54, having the exposed front face and back face 82a, 82b, respectively, and two exposed longitudinal side faces. A cross-section of the base in a plane parallel to the front and back lateral faces 82a,b depicts longitudinal sides gradually tapering inward through the upward extension, and then projecting upwards parallel to the central axis to a top surface that supports a finger or a plurality of fingers as discussed further below.

From the top of base extends finger (and in at least one other embodiment, a plurality of extending fingers), the finger extending substantially parallel to the exposed front and back lateral faces or sides 82a,b, and substantially perpendicular to the housing top portion axial center line 54. Finger(s) further includes on one side a contacting portion forming substantially a first angle and exposed in a first direction with respect to the housing top portion, which presents a camming surface for slidably mating with a filter base drive key.

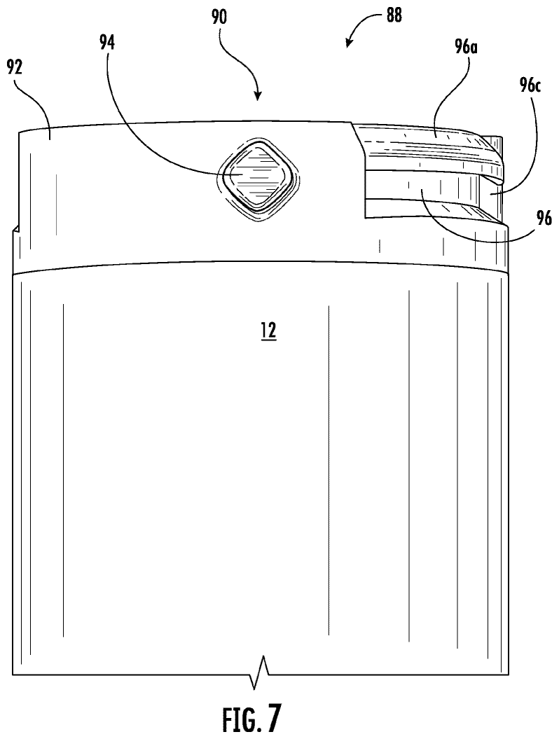

FIG. 7 illustrates a side view of a water filter cartridge including a head, in accordance with an embodiment of the invention. As shown in FIG. 7, the head 92 may include a key 94 and a channel 96. In some embodiments, the key 94 may extend radially outward from the head 92 (e.g., from an outer surface of the head 92 and/or the like). Although not shown in FIG. 7, the head 92 may include another channel positioned on the opposite side of the head 92 from the channel 96. In some embodiments, the channels 96 may be positioned and/or formed on an outer surface of the head 92. Additionally, or alternatively, the channels 96 may be diametrically opposed on the outer surface of the head. In some embodiments, and as described herein, the channels 96 may be structured and/or configured for receiving latching mechanisms, preventing rotation of the filter cartridge in a first direction, and permitting rotation of the filter cartridge in a second direction.

The channel 96 may include a chamfered edge 96a oriented towards the fluid inlet and outlet 90, a vertical sidewall 24b on a first end of the channel 96, and a filleted or curved sidewall 96c on a second end of the channel 96. As described further herein, the chamfered edge 96a, the vertical sidewall 96b, and the filleted sidewall 96c may interact with corresponding features on a lock mechanism on a filter cartridge manifold. As shown in FIG. 7, the key 94 may be shaped as an extruded rhombus with a tip that is sloped from its center, and, as described further herein, the key 94 may interact with keyways in a tube of the filter cartridge manifold. In some embodiments, the key 94 may have a rhomboid-shape and a radially-outward-facing surface that is sloped radially inward from a center of the radially-outward-facing surface.

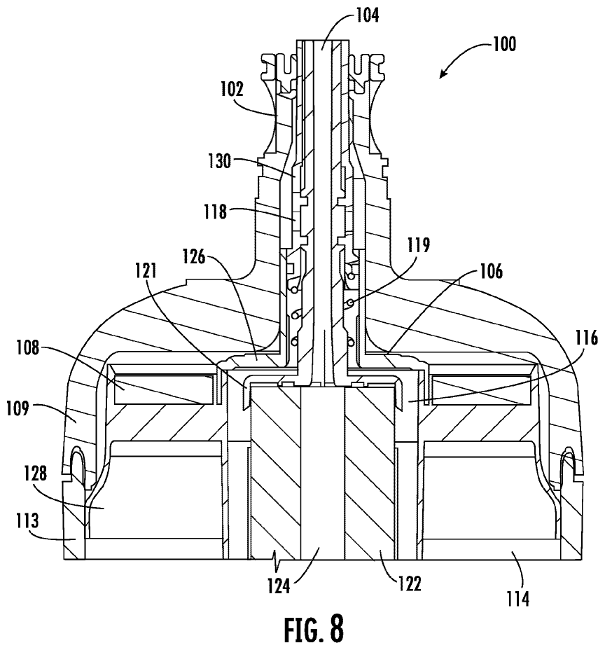

FIG. 8 illustrates a partial cross-sectional view of a water filter cartridge including a head, in accordance with an embodiment of the invention. As shown in FIG. 8, a close-up, cross-section schematic view of a media cartridge 100, where the inlet 102 receives fluid, for example water, to be processed and the outlet 104 receives processed fluid. Fluid entering the media cartridge 100 passes through the inlet 102 and hits valve 130, which is an exemplary bypass regulator, entering the feed chamber 106. The feed then either passes through the feed separator 108 (optional), which aids in keeping the media from escaping the media compartment 114 or through the bypass port 118 into the mixing compartment 116. The amount of fluid going into the mixing compartment 116 is related to the flow through bypass port 118, which is regulated by the valve 130 in conjunction with the elastic device 119 and with a portion of the first/upper end cap 121, which in this embodiment has an extension with one section having a first, enlarged diameter to block the bypass port 118 when the valve is in one position and a second section have a second, narrower diameter to permit flow through the bypass port 118. End cap sleeve 126 in combination with filter element cover 128 contains the filter element 122. Flow of fluid from the bypass port goes through the outer diameter of the filter element 122 and into filter core 124, out the passage of the end cap 121 to outlet 104. Drive 159 imparts linear force on valve 130 in order to adjust the amount of bypass fluid flow.

The body or housing of the cartridge typically comprises a top or sump cover 109 and a sump 113.

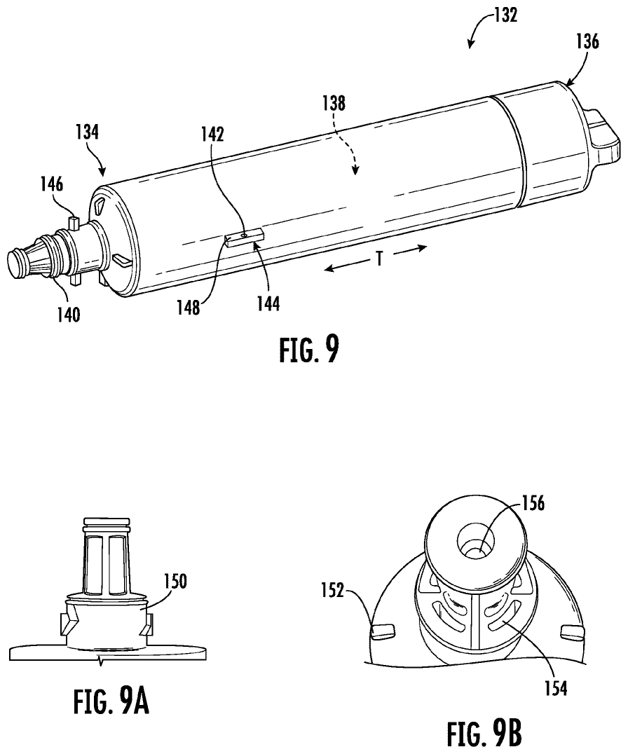

FIG. 9 illustrates a perspective view of a water filter cartridge including a head 134, in accordance with an embodiment of the invention. As shown in FIG. 9, filter cartridge 132 may define an alignment feature 144 and the filter housing may define a complementary feature. In general, filter cartridge 132 is properly installed when the alignment feature 144 engages complementary feature. It should be appreciated that alignment feature 144 and a complementary feature may be any suitable features. For example, according to an exemplary embodiment, alignment feature 144 is one or more radial lugs 146 that extend radially outward from connection 140. Radial lugs 146 may be configured for engaging a complementary keyed slot defined in filter manifold.

Referring still to FIG. 9, alignment feature 144 may include a radially extending member or tag 148 which extends from sidewall of filter cartridge 132. The complementary feature may include a wall or stopping member. In this regard, the stopping member may be defined in a drain trough defined by the filter housing. In this manner, the filter cartridge 132 may be rotated until radially extending tag 148 engages the stopping member to properly position filter cartridge 132 within the filter housing. In this regard, filter cartridge 132 is in the proper position only when radially extending tag 148 extends downward along the vertical direction V. According to an exemplary embodiment, a first contact may be positioned on a stopping member and second contact 142 may be positioned on radially extending tag 148 to form an electrical connection.

FIG. 9A illustrates a perspective view of a head, in accordance with another embodiment of the invention. As shown in FIG. 9A the head may include one or more flanges 150 surrounding the perimeter of at least of portion of the head. The flanges 150 extend radially and are configured to matingly engage with at least a portion of the manifold such as to guide and lock the head in place within the manifold.

FIG. 9B illustrates a perspective view of a head, in accordance with another embodiment of the invention. As shown in FIG. 9B, the head may include at least one tab 152 positioned radially adjacent the perimeter of the outermost portion of the head. The tabs may provide structural rigidity to the head, or function to offset the placement of the head relative the manifold. The head may also include at least one radial slot aperture 154, and aperture 156. Radial slot apertures 154 and aperture 156 may be structures to provide fluid inflow or outflow to the head.

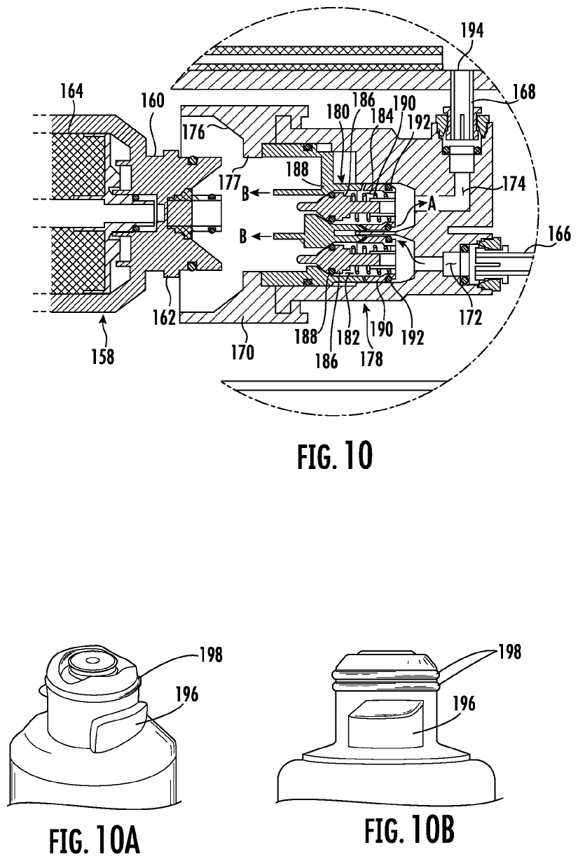

FIG. 10 illustrates a partial cross-sectional view of a water filter cartridge including a head, in accordance with an embodiment of the invention. As shown in FIG. 10, the head is provided with a plug 160 and in turn, the plug 160 is inserted into the valve assembly 178. The plug 160 is formed at an outer peripheral surface thereof with coupling protrusions 162 coupling the valve assembly 178.

Although the present embodiment illustrates the coupling protrusions 162 and holding protrusions 177 as elements to couple or separate the filter assembly 158 to or from the valve assembly 178, this is given only by way of example, and other known elements, such as, e.g., latches or hooks, may be provided. The other end of the filter housing is provided with a plug 160 and in turn, the plug 160 is inserted into the valve assembly 178. The plug 160 is formed at an outer peripheral surface thereof with coupling protrusions 162 coupling the valve assembly 178.

The valve assembly 178 includes a valve housing 170 and a valve unit 180 reciprocally movably provided in the valve housing 170, the valve unit 180 to control the supply of water to the filter assembly 158 and/or the water tank unit. The valve housing 170 is formed in one side thereof with an inlet path 166 for introduction of the water supplied from the water supply source and an outlet path 174 for discharge of the water purified by the filter unit 158. In addition, the other side of the valve housing 170 is provided with a socket 176, into which the plug 160 of the filter assembly 158 is inserted. The inlet path 172 is connected to the first water supply pipe through an inlet pipe 166 and thus, the water supplied from the water supply source is introduced into the inlet path 166 through the first water supply pipe. The socket 176 is formed at an inner peripheral surface thereof with holding protrusions 177 to be caught and supported by the coupling protrusions 162 of the plug 160 when the plug 160 is inserted into the socket 176 and is rotated by 90 degrees.

With the above-described configuration, if the handle is rotated in a given direction by 90 degrees after the filter assembly 158 is inserted into a filter receiving region of the case, the coupling protrusions 162 of the filter assembly 158 are caught and supported by the holding protrusions 177 of the valve assembly 178, completing the installation of the filter assembly 158. Upon replacement of the filter assembly 158, the filter assembly 158 is separable from the case as the handle is pulled out after being rotated in an opposite direction. Although the present embodiment illustrates the coupling protrusions 162 and holding protrusions 177 as elements to couple or separate the filter assembly 158 to or from the valve assembly 178, this is given only by way of example, and other known elements, such as, e.g., latches or hooks, may be provided.

The valve assembly 178, as shown in FIG. 10, has a bypass path A to prevent leakage of water from the valve housing 170 upon separation of the filter assembly 158. The bypass path A is created by the valve unit 180 reciprocally movably provided in the valve housing 170.

Specifically, when the filter assembly 158 is separated from the valve assembly 178, a first communicating path 182 and a second communicating path 184 are closed respectively by shutter members 186. Here, the first communicating path 182 communicates the inlet path 172 and the filter assembly 158 with each other, and the second communicating path 184 communicates the outlet path 174 and the filter assembly 158 with each other.

More specifically, as the shutter members 186 are pressed toward the filter assembly 158 by elastic members 190, the first and second communicating paths 182 and 184 are closed respectively by first sealing members 188 provided at outer peripheral surfaces of the shutter members 186. Also, as the valve unit 180 is moved leftward in a direction represented by the arrows B under the influence of a pressure of the water introduced through the inlet path 172, the bypass path A for communication between the inlet path 172 and the outlet path 174 is created.

On the other hand, when the filter assembly 158 is coupled to the valve assembly 178, the filter assembly 158 presses the valve unit 180 and the shutter members 186, thus causing the bypass path A to be closed by second sealing members 192 while opening the first and second communicating paths 182 and 184.

With the above-described configuration, even if the water supply system is operated during replacement of the filter assembly 158, it may effectively prevent water from being supplied to the filter assembly 158 and consequently, prevent deterioration in the operational reliability of the water supply system due to water leakage.

FIG. 10A illustrates a perspective view of a head, in accordance with the embodiment of FIG. 10. As shown in FIG. 10A, the head may include one or more flanges 196 surrounding the perimeter of at least of portion of the head. The flanges 196 extend radially and are configured to matingly engage with at least a portion of the manifold such as to guide and lock the head in place within the manifold. The head may also include one seal 198 such as an o-ring, gasket, or the like.

FIG. 10B illustrates a perspective view of a head, in accordance with the embodiment of FIG. 10. Similar to the embodiment illustrated in FIG. 10A, the head may include one or more flanges 196 surrounding the perimeter of at least of portion of the head. Unlike the embodiment illustrated in FIG. 10A, the embodiment illustrated in FIG. 10B may include a plurality of seals 198, such as to more effectively sealingly engage with the manifold and create prevent fluid from the inlet of the head from contaminating the fluid from the outlet, and vice versa. Moreover, such seals 198 may also prevent the spillage of fluid into the appliance or outside the manifold.

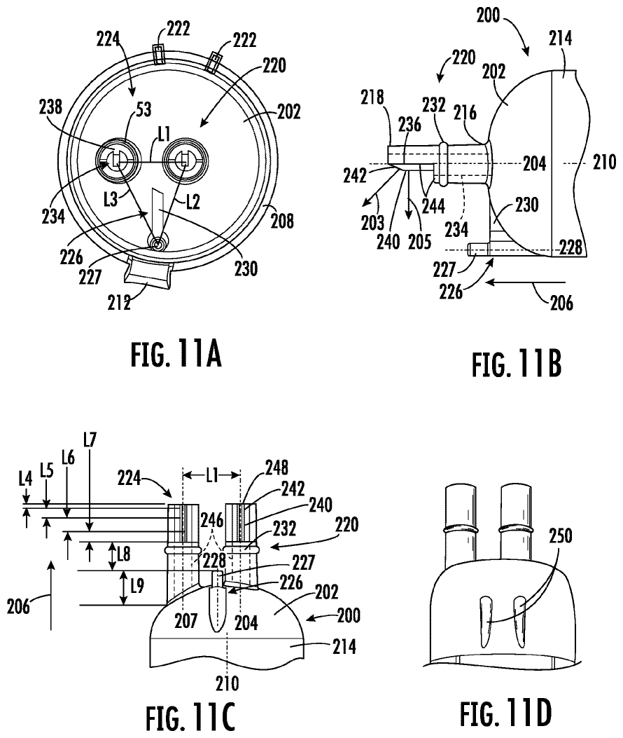

FIGS. 11A-11D illustrate a rear, side, and top plan views of a head, in accordance with an embodiment of the invention. As shown in FIGS. 11A-11C, the head 200 includes an end piece wall 202, an inlet fitting 220, an outlet fitting 224, and a protrusion 226. The cartridge housing 208 may be cylindrical and hollow, having a first end 214 and a closed end opposite the first end 214. The housing 208 may optionally be structurally reinforced by ribs or the like.

The inlet fitting 220 and the outlet fitting 224 extend from the end piece wall 202 such that the inlet fitting 220 is more in-line with the center axis of the cartridge, closer to the center of the end piece wall 202 while the outlet fitting 224 is further from the center axis of the cartridge, on the periphery of the end piece wall 202. It is anticipated that the inlet and outlet fittings 220 and 224 may be reversed, or otherwise arranged. That is, the particular configuration of treatment material (not shown) may dictate the placement of the fittings 220 and 224 in any of several configurations. Each fitting 220 and 224 has a longitudinal axis 204 and 207, respectively. The longitudinal axis 204 and 207 of the fittings 220 and 224 may lie together in only one plane. Also, the solid protrusion 226 may have a cylindrical end (preferably having a length from about 0.1 cm, about 0.3 cm, about 0.5 cm to about 1 cm, about 1.5 cm, about 2 cm, and preferably having a diameter from about 0.1 cm, about 0.2 cm, about 0.3 cm to about 0.5 cm, about 0.7 cm, about 1 cm) extends from near the edge of the end piece wall 202, adjacent to the connection of the head 200 and the cartridge. The protrusion 226 has a longitudinal axis 228. The longitudinal axis 204 of the inlet fitting 220, the longitudinal axis 207 of the outlet fitting 224, the longitudinal axis 228 of the protrusion 226, and the longitudinal axis 210 of the cartridge may be parallel with a line of cartridge insertion 206 into the head assembly. Further, the protrusion 226 is positioned, relative to a side view along the line of insertion 206 of the head 200, between the inlet fitting 220 and the outlet fitting 224 (i.e., no part of the protrusion end 227 exceeds the outer most portion of the inlet or outlet fittings 220 or 224). As shown, the distance LI (preferably from about 0.2 cm, about 0.5 cm, about 0.8 cm to about 2 cm, about 4 cm, about 5 cm) from the longitudinal axis 204 of the inlet fitting 220 to the longitudinal axis 207 of the outlet fitting 224 is less than the distance L2 (preferably from about 0.5 cm, about 0.7 cm, about 1 cm, about 2 to about 3 cm, about 5 cm, about 6 cm) from the longitudinal axis 204 of the inlet fitting 220 to the longitudinal axis 228 of the protrusion 226. Further, as shown, the distance L2 from the longitudinal axis 204 of the inlet fitting 220 to the longitudinal axis 228 of the protrusion 226 is less than the distance L3 (preferably from about 0.7 cm, about 1 cm, about 1.5 cm, about 2 to about 3 cm, about 6 cm, about 7 cm) from the longitudinal axis 207 of the outlet fitting 224 to the longitudinal axis 228 of the protrusion 226. As mentioned above, the inlet and outlet fittings 220 and 224 may be reversed or otherwise arranged, such that the distance L2 would be greater than the distance L3.

The protrusion 226 extends approximately one half the distance of the fittings 220 and 224 from the end piece wall 202. It is the positioning of the protrusion 226 on the head 200 that allows for the protrusion 226 to be rigidly supported by a support bridge 230. While the protrusion 226 may be solid, it is anticipated that the protrusion 226 may also be entirely or partially hollow. The size and possibilities of different arrangements of the inlet and outlet fittings 220 and 224 and the protrusion 226 contribute to the compactness of the head assembly. An outwardly biased latch 212 is disposed on the outer surface of the hollow housing 208 just before the second end. The latch 212 is capable of being releasably engaged by an appliance, as described in more detail below. As shown, opposite the latch 212, on the outer surface of the hollow housing 208 are two guide rails 222 which run along the longitudinal axis 210 of the cartridge approximately one quarter the length of the cartridge. A treatment material (not shown) is disposed within the interior space of the housing 208 and is in fluid communication with the inlet fitting 220 and the outlet fitting 224.

The inlet fitting 220 of the head 200 will now be described in detail. Since the inlet fitting 220 and the outlet fitting 224 can be similarly configured, only the inlet fitting 220 will be described herein. However, it is understood that the same description may be equally applicable to the outlet fitting 224. The inlet fitting 220 (preferably having a length from about 1.5 cm, about 2 cm, about 2.5 cm to about 3 cm, about 4 cm, about 5 cm) extends outwardly away from the end piece wall 202 and is cylindrically shaped (preferably having an inside diameter from about 0.3 cm, about 0.5 cm, about 0.6 cm to about 1 cm, about 1.2 cm, about 1.5 cm, and preferably having an outside diameter from about 0.5 cm, about 0.8 cm, about 1 cm to about 1.5 cm, about 1.8 cm, about 2 cm) at its proximal end 216 adjacent the end piece wall 202. A channel 234 runs the length of the inlet fitting 220. The channel 234 meets the cartridge housing 208 such that the inlet fitting 220 is in fluid communication with the interior space of the hollow cartridge housing 208 and thus the treatment material (not shown). The channel 234 has an opening (preferably having a diameter from about 0.3 cm, about 0.5 cm, about 0.6 cm to about 1 cm, about 1.3 cm, about 1.5 cm) and an open portion (as used herein, the term “open portion” refers to the portion of a fitting which remains after a portion of it has been cut away and such portion would have, if not cut away, continued to form and define the fitting) 244 (preferably having a length from about 0.5 cm, about 0.8 cm, about 1 cm to about 2 cm, about 3 cm, about 4 cm, and preferably having a height from about 0.1 cm, about 0.3 cm, about 0.5 cm to about 1 cm, about 1.5 cm, about 2 cm, and preferably having a width from about 0.4 cm, about 0.7 cm, about 1 cm to about 1.5 cm, about 2.5 cm, about 3 cm) at the distal end 218 of the fitting 220. The open portion 244 is adjacent the protrusion 226, and permits water to easily flow from and to the opening. The channel 234 is exposed at the open portion 244. An o-ring 232 (preferably having an outside diameter from about 0.5 cm, about 0.8 cm, about 1 cm to about 2 cm, about 3 cm, about 4 cm) encircles the inlet fitting 220 and is placed adjacent the open portion 244, between the open portion 244 and the proximal end 216 of the inlet fitting 220. An actuation wall 236 (preferably having a length from about 0.4 cm, about 0.7 cm, about 1 cm to about 2 cm, about 2.5 cm, about 3 cm) extends away from the base 238 of the channel 234 of the inlet fitting 220 running along the direction of the longitudinal axis 204 of the inlet fitting 220. The actuation wall 236 has a flat portion 240 (preferably having a length from about 0.1 cm, about 0.4 cm, about 0.6 cm to about 1.5 cm, about 2 cm, about 3 cm, and preferably having a height from about 0.1 cm, about 0.2 cm, about 0.4 cm to about 1 cm, about 2 cm, about 3 cm, and preferably having a width from about 0.05 cm, about 0.1 cm, about 0.15 cm to about 0.3 cm, about 0.5 cm, about 1 cm) and an angled portion 242 (preferably having a length from about 0.1 cm, about 0.2 cm, about 0.4 cm to about 1 cm, about 2 cm, about 3 cm, and preferably having a height, at its highest point, from about 0.1 cm, about 0.2 cm, about 0.4 cm to about 1 cm, about 1.5 cm, about 2 cm, and preferably having a height, at its lowest point, from about 0 cm, about 0.1 cm, about 0.2 cm to about 0.5 cm, about 1 cm, about 1.5 cm, and preferably having a width from about 0.05 cm, about 0.08 cm, about 0.15 cm to about 0.25 cm, about 0.5 cm, about 1 cm) between the flat portion 240 and a leading portion 248 (preferably having a height from about 0 cm, about 0.1 cm, about 0.2 cm to about 0.5 cm, about 1 cm, about 1.5 cm, and preferably having a width from about 0.05 cm, about 0.1 cm, about 0.15 cm to about 0.5 cm, about 0.8 cm, about 1 cm) of the actuation wall 236.

The sum of the leading portion 248, the angled portion 242, and the flat portion 240 together, in this embodiment, form a cam surface which engages a follower, a described hereafter. The surface may include more or less surfaces which physically touch a follower for the purpose of actuation. These surfaces may or may not be continuous. In the preferred embodiment, each of the three surfaces (leading portion 248, angled portion 242, and the flat portion 240) have different functions, as discussed more fully hereafter.

However, a cam surface, as defined by this invention, may optionally include a surface having multiple functions to actuate a valve. For instance, the same surface may move a follower, opening a valve, and also hold the follower in place, so that the valve stays open. Also, it should be pointed out that the cam surface of the actuation wall 236 may be angled and/or vectored in relation to the longitudinal axis 204 of the inlet fitting 220, the longitudinal axis 207 of the outlet fitting 224, the longitudinal axis 228 of the protrusion 226, the longitudinal axis 210 of the cartridge, and/or the line of insertion 206 of the cartridge, as discussed more fully hereafter. As shown in FIG. 11B, the angled portion 242 of the cam surface is illustrated with an essentially straight surface which is angled approximately 45 degrees relative to the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge. As is apparent from FIG. 11B, angled portion 242 has a vector 203 which has a radial component which extends approximately 45 degrees from the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge. Since the vector 203 of the angled portion 242 has a radial component in relation to the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge, the angled portion 242 of the cam surface is vectored. That is, the angled portion 242 radially faces away from the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge approximately 45 degrees. Further, as shown in FIG. 11B, the flat portion 240 of the cam surface is illustrated with an essentially straight surface which is essentially not angled (that is, essentially parallel) relative to the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge. As is apparent from FIG. 11B, flat portion 240 has a vector 205 having a radial component which extends approximately 90 degrees from the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge. Since the vector 205 of the flat portion 240 has a radial component in relation to one or more of the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge, the flat portion 240 of the cam surface is vectored. That is, the flat portion 240 radially faces away from the longitudinal axis 204 of the inlet fitting 220, the longitudinal axis 207 of the outlet fitting 224, the longitudinal axis 228 of the protrusion 226, the longitudinal axis 210 of the cartridge, and the line of insertion 206 of the cartridge approximately 90 degrees. Further, since the vector 205 of the flat portion 240 is essentially radial only, the flat portion 240 is fully vectored.

The cam surface of the actuation wall 236 contributes to the compactness and mechanical advantage of the invention, each of which is discussed more fully hereafter. The height of the actuation wall 236 is less than the inside diameter of the channel 234 of the inlet fitting 220 in order to provide a less obstructed channel 234 for the fluid to enter. The opening permits a fluid to pass through the channel 234 of the inlet fitting 220 and enter the interior space of the cartridge housing 208. The channel 234 is aligned with the longitudinal axis 210 of the cartridge so that the fluid entering the opening of the inlet fitting 220 flows in a direction of the longitudinal axis 210 of the cartridge housing 208 through the channel 234.

For the purpose of further describing one embodiment, but not for the purpose of limitation, and as shown in FIG. 11C, the most distal portion of the protrusion end 227 to the most proximal portion of the inlet fitting 220 is preferably a distance (L9) from about 0.5 cm, about 0.7 cm, about 1 cm to about 1.5 cm, about 2 cm, about 2.5 cm, and the most distal portion of the protrusion end 227 to the most distal portion of the inlet fitting 220 is preferably a distance (L4 through L8) from about 1 cm, about 2 cm, about 2.5 cm to about 4 cm, about 4.5 cm, about 5 cm. The most distal portion of the protrusion end 227 to the most proximal portion of the open portion 244 is preferably a distance (L8) from about 0.5 cm, about 1 cm, about 1.5 cm to about 3 cm, about 4 cm, about 5 cm, and the most distal portion of the protrusion end 227 to the most distal portion of the open portion 244 is preferably a distance (L4 through L8) from about 1 cm, about 2 cm, about 2.5 cm to about 4 cm, about 4.5 cm, about 5 cm. The most distal portion of the protrusion end 227 to the most proximal portion of the actuation wall 236 is preferably a distance (L8) from about 0.5 cm, about 1 cm, about 1.5 cm to about 3 cm, about 4 cm, about 5 cm, and the most distal portion of the protrusion end 227 to the most distal portion of the actuating wall 236 is preferably a distance (L4 through L8) from about 1 cm, about 2 cm, about 2.5 cm to about 4 cm, about 4.5 cm, about 5 cm. The most distal portion of the protrusion end 227 to the most proximal portion of the flat portion 240 is preferably a distance (L7 through L8) from about 1 cm, about 1.5 cm, about 2 cm to about 3 cm, about 4 cm, about 5 cm, and the most distal portion of the protrusion end 227 to the most distal portion of the flat portion 240 is preferably a distance (L6 through L8) from about 1 cm, about 1.5 cm, about 2 cm to about 3 cm, about 4 cm, about 5 cm. The most distal portion of the protrusion end 227 to the most proximal portion of the angled portion 242 is preferably a distance (L6 through L8) from about 1 cm, about 1.5 cm, about 2 cm to about 3 cm, about 4 cm, about 5 cm, and the most distal portion of the protrusion end 227 to the most distal portion of the angled portion 242 is preferably a distance (L5 through L8) from about 1.5 cm, about 2 cm, about 2.5 cm to about 4 cm, about 4.5 cm, about 5 cm. The most distal portion of the protrusion end 227 to the leading portion 248 is preferably a distance (L5 through L8) from about 1.5 cm, about 2 cm, about 2.5 cm to about 4 cm, about 4.5 cm, about 5 cm.

While the length of the inlet fitting 220 preferably has a length from about 0.5 cm, about 0.8 cm, about 1 cm to about 4 cm, about 6 cm, about 7 cm, it may be at least about 0.5 cm and greater, without limitation, because it is application of this invention which dictates size, and such application may be residential or industrial. The same is true for any physical feature of this invention, including, but not limited to, the channel 234 of the inlet fitting 220, outlet fitting 224, protrusion 226, the opening, the open portion 244, the o-ring 232, the actuating wall 236, the cam surface, etc.

Further regarding the inlet fitting 220, it should be understood that the inlet fitting 220 may be various lengths for purposes which include controlling the timing of valve actuation. Also, the inlet fitting 220 may be various diameters for reasons which include ensuring that the inlet fitting 220 is placed into the correct receiving port housing. The inlet fitting 220 need not be circular as the inlet fitting 220 may be any number of various dimensions. Regarding the actuation wall 236 of the inlet fitting 220, the actuation wall 236 height may exceed the inside diameter of the channel 234 of the inlet fitting 220 or, as previously described, the height may be less than the inside diameter channel 234 of the fitting 220. Additionally, the actuation wall 236 may exceed the length of the channel 234 or may occupy only the distal end 218 of the inlet fitting 220. However, it should be understood that there should be enough actuation wall 236, and more particularly, cam surface, both in height, length, and width, to actuate a valve. Additionally, regarding the open portion 244 in relation to the actuation wall 236, the open portion 244 may be more open than closed, or may be more closed than open. However, it should be understood that enough of the actuation wall 236 should be exposed by the open portion 244 so that physical contact between the follower and the cam surface of the actuation wall 236 can occur to facilitate actuation of the valve. Alternatively, the actuation wall 236 may extend from the outside of the inlet fitting 220 instead of from the base 238 the channel 234 of the inlet fitting 220, eliminating a need for an open portion 244. The cam surface of the actuation wall 236 may be angled in relation to the longitudinal axis 204 of the inlet fitting 220, the longitudinal axis 207 of the outlet fitting 224, the longitudinal axis 228 of the protrusion 226, and/or the longitudinal axis 210 of the cartridge (preferably having an angle from about 1 degree, about 10 degrees, about 15 degrees, to about 40 degrees, about 60 degrees, about 90 degrees). Also, the cam surface of the actuation wall 236 may be vectored in relation to one or more of the longitudinal axis 204 of the inlet fitting 220, the longitudinal axis 207 of the outlet fitting 224, the longitudinal axis 228 of the protrusion 226, and/or the longitudinal axis 210 of the cartridge (preferably vectored from about 1 degree, about 10 degrees about 15 degrees, to about 40 degrees, about 60 degrees, about 90 degrees) such that cam surface, or portion thereof, may be partially or fully vectored. In the preferred embodiment, width and length of the angled portion 242 of the actuation wall 236, between the leading portion 248 and the flat portion 240, may vary, as well as the degree which the angled portion 242 is angled and/or vectored from the longitudinal axis 204 of the inlet fitting 220, the longitudinal axis 207 of the outlet fitting 224, the longitudinal axis 228 of the protrusion 226, the longitudinal axis 210 of the cartridge, and/or the line of insertion 206, as long as the cam surface of the actuation wall 236 adequately contacts a follower to facilitate actuation of a valve in an essentially orthogonal actuation motion relative to the longitudinal axis 204 of the inlet fitting 220, the longitudinal axis 207 of the outlet fitting 224, the longitudinal axis 228 of the protrusion 226, the longitudinal axis 210 of the cartridge, and/or the line of insertion 206.

As mentioned earlier, the cam surface of the actuation wall 236 contributes to the compactness of the head assembly. That is, the essentially orthogonal actuation motion caused by the cam surface of the actuation wall 236 allows for inlet and outlet passageway housings and inlet and outlet valves to be positioned essentially perpendicular to the line of insertion 206 of the cartridge. Such positioning allows for a head assembly to be shorter in length (the distance in-line with the line of insertion 206 of the cartridge) because a head assembly needs only to be a length sufficient to accommodate receiving port housings (e.g., outlet fitting and inlet fitting receiving port housings) which contain only a portion of a follower. Receiving port housings (e.g., outlet fitting and inlet fitting receiving port housings) can be much shorter in length than a valve (e.g., inlet and outlet valves). Thus, the result of positioning of valves, passageway housings, and the port housings allows for a longer cartridge per fixed distance. Thus, when the compact orientation of a head assembly is discussed, it should be kept in mind that the cam surface of the actuation wall 236 is responsible, in part, for allowing the particular orientation of a head assembly.

In some embodiments, and as illustrated in FIG. 11D, projecting along the top and/or bottom faces of the head are a plurality of fins 250, structured to matingly engage with the manifold portion to which the head is coupled.

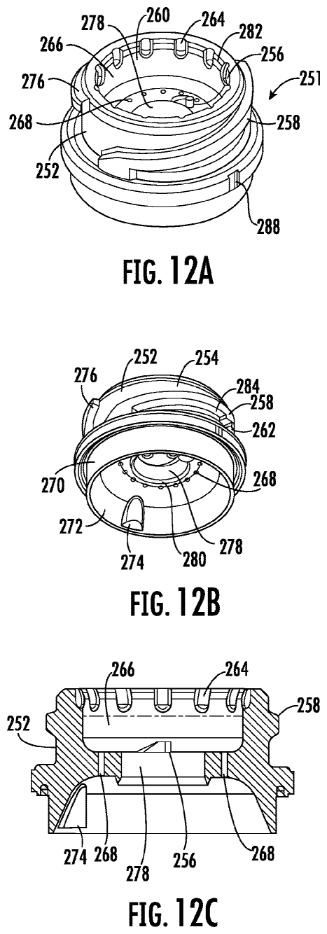

FIGS. 12A and 12B illustrate perspective views of a head, in accordance with an embodiment of the invention. FIG. 12C illustrates a cross-section view of a head, in accordance with the embodiment of FIGS. 12A-12B. As shown in FIGS. 12A-12C, cartridge top member 251 may include member body 252. Member body 252 may have a margin 254 from which exterior helical tabs 258 operatively connect with interior helical tabs of a cartridge receiver. As with the interior helical tabs, exterior helical tabs 258 may spiral upward at an approximate 8 degree angle along margin 254 to a position less than half the circumference away from their point of origin. The underside surface 284 of these tabs may be supported by a top surface of the interior helical tabs of the manifold assembly. Exterior helical tabs 258 may have at their end points ramps 276 for facilitating engagement with interior helical tabs.

Cartridge top member body 252 may have defined therein interior receiver well 260 with inside margin 254 for sealing with O-ring of the manifold assembly. This effects a fluid seal between unfiltered inlet water within receiver well 260 and the cavity of the manifold assembly body.

As illustrated in FIG. 12A-12C, a plurality of inlet orifices 268 may be formed within the bottom surface of receiver well 260. These orifices 268 may be spaced circumferentially and equidistant from each other, although other spacing and numbers of orifices can be used, as would be understood by one skilled in the art. A distinct feature of these orifices 268 is that the inside diameter of any individual orifice is designed such that the adhesive forces between the inside surface and any remaining water within that orifice may allow for capillary action to prevent dripping when the cartridge assembly is disengaged from the manifold assembly. These orifices 268 may direct inlet water to cartridge housing.

Outlet bore 278 may be bored through the center of cartridge top member 251. Within outlet bore 278 reduced body portion of cartridge insert may be engaged for conveyance of filtered water. A lip 280 may protrude from the underside of outlet bore 278, providing proper positioning of filter within cartridge assembly. Dual ramps 256 may extend upward from the bottom of receiver well 260. One or the other of the ramps 256 may radially align with high-flow valve contact surface to compress and open the valve when cartridge top member 251 is rotatably moved into place to operatively connect with manifold assembly.

The underside surface 284 of each helical tab 258 may have a locking tab 262 for operatively connecting with a cooperative depression located in the interior helical tab of manifold assembly. As will be seen, these locking tabs 262 may interface with the depressions during engagement of the cartridge assembly with the manifold assembly to lock the cartridge assembly in place and to provide a degree of burst protection to the components of filter assembly, i.e. to resist unexpected disconnection of the cartridge assembly from the manifold assembly. The locking tabs 262 may disengage from the respective depressions permitting the cartridge assembly to back off from manifold assembly at a predefined level of hydraulic pressure for the benign disengagement thereof.

Without locking tabs 262, normal pressure levels of the incoming water service and associated vibrations would slowly cause the cartridge assembly to disconnect from manifold assembly, resulting in leakage and the eventual total disengagement of the cartridge assembly from the manifold assembly. One unique feature, among others, of locking tabs 262 in the representative embodiment of the Figures, is that they can be designed such that they do not allow for this gradual disconnecting of the filter assembly under normal line pressure conditions and within normal line pressure tolerances, but will commence disconnecting at a certain pressure condition below the structural strength limits of the filter assembly. Generally, normal line pressure conditions range from about 20 psig to about 120 psig. In this representative embodiment and in other representative embodiments such as those described below, the filters can be designed to disconnect at pressures above about 120 psig, and in other presently preferred embodiments at pressures above a value from about 150 psig to about 180 psig. A person of ordinary skill in the art will recognize that additional ranges of pressure values within these explicit pressure ranges are contemplated and are within the present disclosure. The design of the locking tabs 262 may determine this pressure condition by being a more aggressive design, such as with deeper depressions, or a less aggressive design, such as with shallower depressions, a more aggressive design seating more firmly in the depression and requiring greater pressure relative to less aggressive designs to unseat the locking tabs 262 from the depressions.

As illustrated in FIG. 12B, the cartridge top member 251, has a surface 270 extending circumferentially from body 252. The interior face 272 of surface 270 may progressively slope centerward to inlet orifices 268. This slope allows for a smoother transition and flow pattern from the interior space within surface 270. Also, on the interior face 272 may be two weld facilitators 274. The weld facilitators 274 may be diametrically opposed from each other.

As illustrated in FIGS. 12A and 12C, defined around the perimeter of upper sealing surface 266 of receiver well 260 may be a plurality of vent ports 264. Vent ports 264 may be spaced equidistant around the diameter of sealing surface 266. These vent ports 264 may separate the surface 266 from the interior cavity of the manifold assembly body, as shown in FIG. 1. As will be seen, these vent ports 264 may allow for relief of pressure trapped in the cartridge assembly before complete disengagement during the disassembly of the cartridge assembly from manifold assembly. The top edge 282 of receiver well 260 may be chamfered to facilitate this relief of pressure.

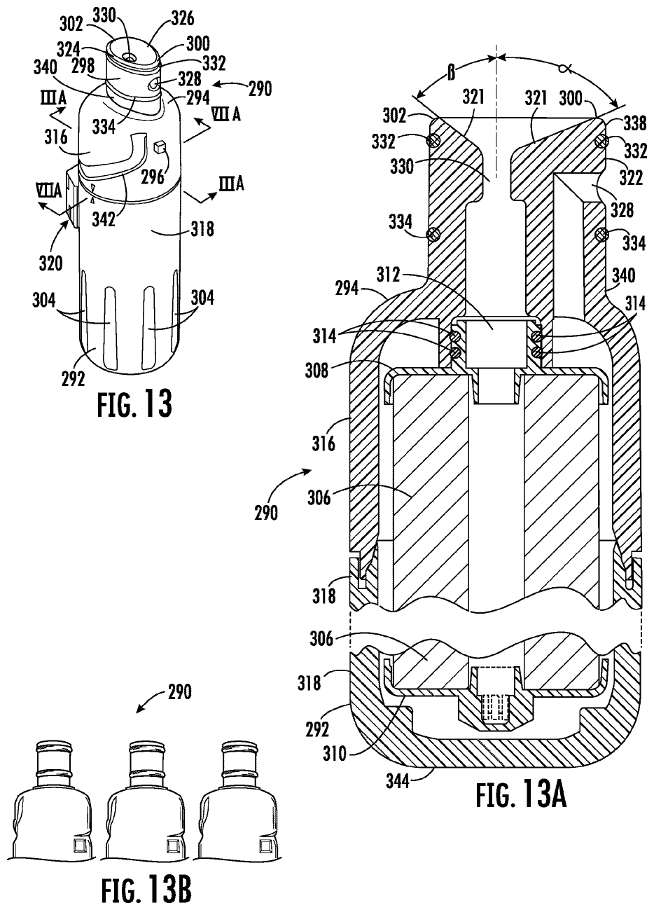

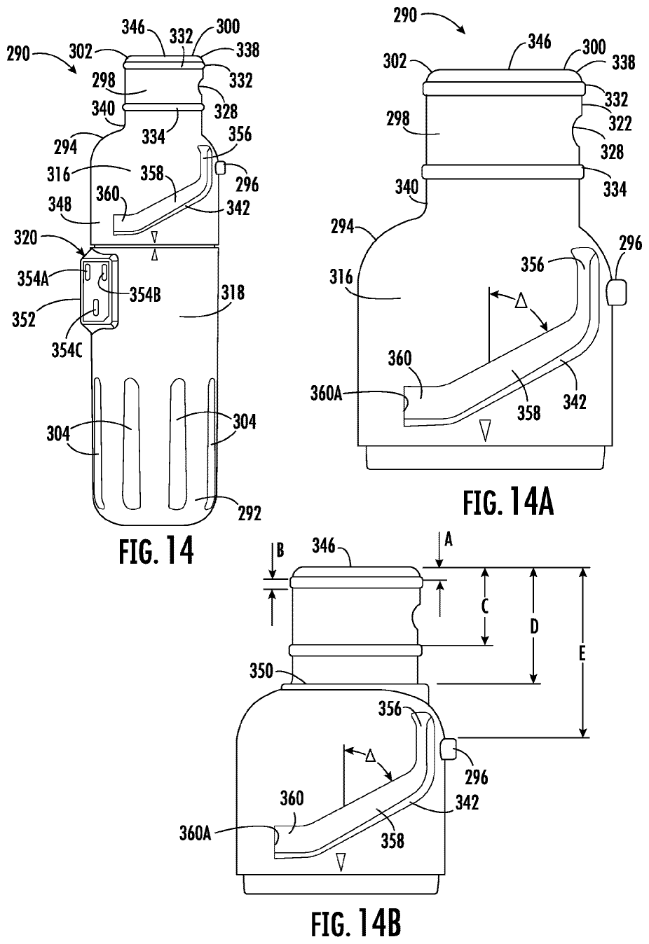

FIGS. 13-14B illustrate perspective views and cross-section views of a head, in accordance with an embodiment of the invention. As shown in FIGS. 13-14B, the body portion 348 of the filter unit 290 includes a cylinder-like construction having a diameter that is easily graspable by the hand of a user. A multitude of grasping cutouts 304 are disposed on the body portion 348 and extend toward the distal end of the body portion 348 and are designed to provide a gripping surface for a user to both engage and disengage the filter unit 290 from the filter head assembly. As disclosed in further detail herein, engagement of the filter unit 290 typically includes rotational and longitudinal movement of the filter unit 290 relative to the filter head assembly. The end cap 308 includes an outlet 312 that relays filtered water out of the filtering media 306 after the water has been filtered. Seals 314 prevent cross-contamination of unfiltered water with filtered water that has passed through the filtering media 306. As shown in FIG. 14B, the distance A from a distal protrusion surface 346 of the filter unit 290 to a first seal 322 is approximately 2.69 millimeters. The first seal 322 and a second seal 334 have a thickness B of approximately 2.62 millimeters. The distance C between the distal protrusion surface 346 and the second seal 334 is approximately 18.69 millimeters, while the distance D from the distal protrusion surface 346 to a shoulder support 350 is approximately 28.30 millimeters. Finally, the distance E from the distal protrusion surface 346 to the laterally extending key member 296 is approximately 41.20 millimeters. The dimensions noted above are specifically configured to complement and interact with the filter head assembly, thereby allowing for tight and secure engagement of the filter unit 290 with the filter head assembly.

The engagement protrusion 298 is centrally aligned as viewed from the front. However, the engagement protrusion 298 is offset as viewed from the side. Thus, the engagement protrusion 298 is generally disposed in an offset position on the proximal end of the filter unit 290. Further, the outlet 332 is generally aligned with a central longitudinal axis that extends longitudinally through the center of the filter unit 290. The laterally extending key member 296 can be constructed in a variety of shapes. For example, the laterally extending key member can include a rectangular shape, a cylindrical shape, or any other shape adapted to interface with the key slot. Regardless of the shape, the laterally extending key member 296 generally has a width of approximately 2.75 millimeters, a height of approximately 2.75 millimeters, and extends approximately 27.73 millimeters from the central longitudinal axis.

The body portion 348 of the filter unit 290 is defined by a forward casing 316 and a rearward casing 318 that are placed in abutting engagement over the water filter disposed inside the filter unit 290. The forward casing 316 may be attached to the rearward casing 318 in any known manner, such as by heat staking, welding, or mechanical fastener attachment. Alternatively, it is contemplated that the body portion 348 could include one integral casing formed from a single part. The engagement protrusion 298 extends from the proximal end 294 of the filter unit 290 and is smaller in cross-sectional area than the body portion 348 of the filter unit 290. The body portion 348 tapers gradually from the proximal end 294 to the distal end 292.

Referring to FIG. 13A, an engagement or end wall 321 of the engagement protrusion 298 is integral with a sidewall 332 of the engagement protrusion 298 and has a concave construction that tapers downwardly to an end aperture, which constitutes an outlet 330 of the filter unit 290. A side aperture, which constitutes an inlet 328, is positioned in the sidewall 332 of the engagement protrusion 298. For purposes of description, as viewed in FIG. 13A, the filter unit 290 is described in an upright position, wherein the longitudinal axis of the filter unit 290 is in a substantially vertical orientation. In the illustrated embodiment, an angle α2 of the engagement wall 321 adjacent to the first portion 300 has an angle approximately 67.7 degrees from vertical. It is contemplated that the angle α2 could be as low as 15 degrees or as high as 90 degrees. An angle α1 of the engagement wall 321 of the engagement protrusion 298 at the second portion 302 of the engagement protrusion 298 is approximately 51 degrees, although it is contemplated that the angle α1 could be as low as 5 degrees or as high as 85 degrees. It will be noted that the degrees and constructions of the engagement wall 321 may vary from these specified angles and still be within the scope of the present invention. The angle θ of the engagement wall 321 in the engagement protrusion 298 is approximately 46.9 degrees from vertical on both third and fourth portions 324, 326 of the engagement protrusion 298. It is contemplated that the angle θ could be as low as 10 degrees or as high as 85 degrees. As illustrated, the first and second portions 300, 302 of the engagement protrusion 298 are not symmetrical, while the third and fourth portions 324, 326 of the engagement protrusion 298 are generally symmetrical.

Referring again to the embodiments of FIG. 13A, the inlet 328 and the outlet 330 of the filter unit 290 have approximately the same diameter to dissipate extreme water pressure increases or decreases in the system. Nevertheless, it is contemplated that the diameter size of the inlet 328 and the outlet 330 could differ. Additionally, the engagement protrusion 298 includes first and second seals 322, 334, wherein the first seal 322 is disposed above the inlet 328 near a forward edge 338 of the engagement protrusion 298, and the second seal 334 is disposed between the inlet 328 and a base portion 340 of the engagement protrusion 298. Both the first and second seals 322, 334 extend around the sidewall 332 of the engagement protrusion 298. The first seal 322 keeps incoming unfiltered water entering the inlet 328 from cross-contaminating with exiting filtered water leaving the outlet 330. Therefore, the first seal 322 acts as a barrier, keeping the water to be filtered separate from the filtered water. The second seal 334 acts as a barrier that prevents filtered water from leaking around the body portion 348 during use.

Referring now to FIG. 14, a shoulder on the proximal end 294 of the filter unit 290 includes the laterally extending key member 296, which is adapted to interface with and disengage an interference member disposed in the filter head assembly, as outlined in further detail herein. The laterally extending key member 296, as illustrated, includes a square shape. The laterally extending key member 296 may extend out from the body portion 348 approximately 0.5 to 10 mm. In the illustrated embodiment, the laterally extending key member 296 extends out from the body portion 348 approximately 2.75 mm. However, it is contemplated that the shape of the laterally extending key member 296 could also be circular, oval, polygonal, etc. The laterally extending key member 296 includes a profile height that is adapted to be received in a key slot inside the filter head assembly. The key slot includes three segments that define the key slot shape. A first segment is substantially linear and parallel with the longitudinal extent of the filter head assembly. A second segment extends at an angel between 0 degrees and 98 degrees relative to the longitudinal extent of the filter head assembly. A third segment extends substantially laterally or normal to the longitudinal extent of the filter head assembly. The third segment may angle back 0 degrees to 25 degrees to provide a detent-type configuration that is adapted to secure the laterally extending key member 296 in place in the key slot of the filter head assembly. A retention nub may be disposed in the third segment to assist in securing the laterally extending key member 296 in place. As shown in the illustrated embodiment, the engagement protrusion 298 may include a straight walled construction designed to engage the manifold and be received in a manifold. The engagement surface 342 are disposed on the filter unit on opposite sides thereof. The illustrated embodiment depicts the engagement surface 342 in the form of channeled grooves. However, it is contemplated that the engagement surface 342 could be formed from externally protruding walls, or a combination of grooves and externally protruding walls, among other possible constructions. Similar to the laterally extending key member 296, the engagement surface 342 is shown having a square shape. However, it is contemplated that the square shape of the engagement surface 342 could also be circular, oval, polygonal, etc. Similar to the key slot, the engagement surface 342 includes three segments. Specifically, each of the engagement surface 342 includes a first segment 356 that is substantially linear and parallel with the longitudinal extent of the body portion of the filter unit. A second segment 358 of the engagement surface 342 extends at an angle between 0 degrees and 342 degrees relative to the longitudinal extent of the body portion of the filter unit. In the illustrated embodiment, the angle A of the second segment 358 of the engagement surface 342 is 62 degrees from vertical. A third segment 360 of the engagement surface 342 extends substantially laterally or normal to the longitudinal extent of the body portion of the filter unit. Alternatively, the third segment 360 may angle back 0 degrees to 25 degrees to provide a detent-type configuration that is adapted to secure the first and second guides in place after engagement of the filter unit with the manifold. Each of the first, second, and third segments 356, 358, and 360 of the engagement surface 342 provide a smooth engagement of the filter unit with the manifold during installation of the filter unit.

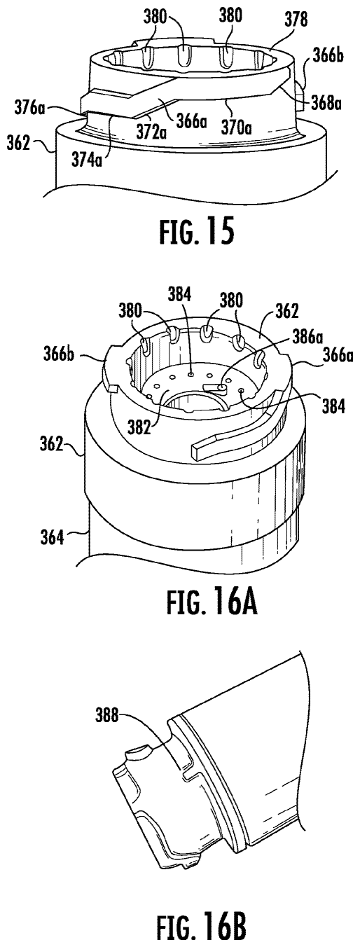

FIGS. 15-16B illustrate perspective views of a head, in accordance with an embodiment of the invention. As shown in FIGS. 15-16B, a filter cartridge comprises a filter cap 362, a filter media and a filter body 364 is illustrated in which the filter cartridge can be used to compete a two stage engagement structure. The filter media can comprise a wide variety of filtering medias for example depth filtration media, surface filtration media, sand filtration media, activated carbon filtration media, ion exchange filtration media, cross-flow membrane filtration media and hollow fiber filtration media. Filter cap 362 and filter body 364 can be fabricated of suitable polymeric materials such as polypropylene, polycarbonate or polyethylene. Alternatively, the filter cartridge can be fabricated from modified polyolefins such as, for example, metallocene modified polypropylene or polyethylene polymers and copolymers as well as either high or low density polyethylene polymers, having advantageous properties such as increased strength, elasticity or increased ultimate elongation percentages such as disclosed in U.S. patent application Ser. No. 10/377,022, published as U.S. Pat. Pub. No. 2004/0094468 A1, which is herein incorporated by reference to the extent not inconsistent with the present disclosure. In some embodiments, filter cap 362 may be constructed of a first polymer, such as polypropylene, having a specific quality such as, for example, strength or rigidity while filter body 364 is constructed of a second polymer having a different design quality such as, for example, increased ultimate elongation percentage or increased stretch, with suitable polymers being metallocene modified polypropylene or polyethylene polymers and copolymers as well as either high or low density polyethylene polymers. Filter cap 362 and filter body 364 are operatively joined using any suitable joining technique such as, for example, an engageable thread or other alternative joining techniques such as adhesives, heat welding, spin welding, ultrasonic welding and the Like. The filter cartridge generally comprises an attachment end and a handling end.

Filter cap 362 can comprise a pair of opposed and identically configured multi-stage filter attachment members 366a, 366b. As clearly illustrated in FIGS. 15-16B, multi-stage filter attachment member 366a can comprise a first angled portion 368a adjacent to the first horizontal portion, a first horizontal portion 370a facing toward the filter body, a second angled portion 372a adjacent to the first horizontal portion, a second horizontal portion 374a facing toward the filter body, and a third angled portion 376a adjacent to the second horizontal portion while correspondingly, multi-stage filter attachment member 366b can comprise a first angled portion 368b, a first horizontal portion 370b, a second angled portion 372b, a second horizontal portion 374b and a third angled portion 376b.

As clearly illustrated in FIGS. 15-16B, filter cap 362 comprises a projecting insertion wall 378. A plurality of venting notches 380 is spaced about the inner rim of the insertion wall 378, although a single vent or a different number of venting notches can be used relative to the venting notches shown in the Figures. Filter cap 362 further comprises an interface surface 382 having a plurality of feed throughbores 384 and a return throughbore 328. As illustrated, interface surface 382 can further comprise a pair of arcuate kick-off ramps 386a, 386b. Moreover, as illustrated in FIG. 16B, filter cap 362 may comprise a notch 388 at the base of the insertion wall 378, the notch 388 sized to engage with a corresponding notch within the manifold in which the filter cap 362 is installed.

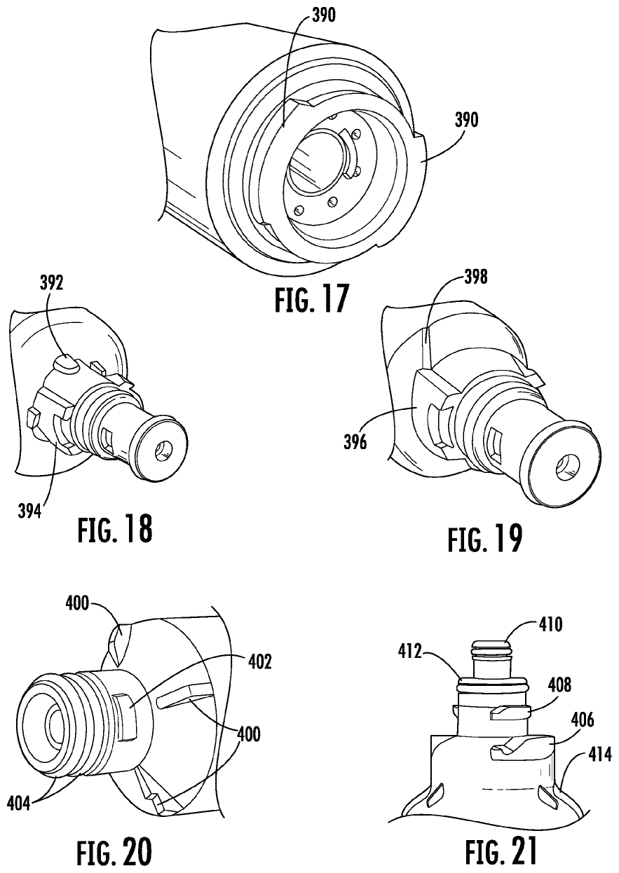

The head 206 of the reusable water filter cartridge may also have numerous other embodiments, with elements as will be described with respect to FIGS. 17-24 henceforth.

FIG. 17 illustrates a perspective view of a head, in accordance with an embodiment of the invention. As shown in FIG. 17, the head may include a plurality of tabs 390, which are positioned adjacent the first end of the head and extend radially outwards. The tabs 390 are structured to matingly engage with corresponding apertures in the manifold.

FIG. 18 illustrates a perspective view of a head, in accordance with an embodiment of the invention. As shown in FIG. 18, the head may include at least one rib 392, the at least one rib 392 structured to extend between a cylindrical portion in the axial direction of the head and an adjacent face of the head extending in a primarily orthogonal direction from the cylindrical portion. The rib 392 may provide additional structural support and/or matingly engage with corresponding features or apertures in the manifold. Moreover, the head may also include a key 394 extending radially outward along the cylindrical portion of the head, structured to matingly engage with corresponding tabs or slots of the manifold.

FIG. 19 illustrates a perspective view of a head, in accordance with an embodiment of the invention. As shown in FIG. 19, the head may include a key 396 extending radially outward along the cylindrical portion of the head, structured to matingly engage with corresponding tabs or slots of the manifold. Moreover, the head may include at least one fin 398 at the base of the head, extending towards the first end of the head.

FIG. 20 illustrates a perspective view of a head, in accordance with an embodiment of the invention. As shown in FIG. 20, the base portion of the head may include a plurality of fins 400, the fins 400 extending towards the first end of the head. The head may also include a key 402 extending radially outward along the cylindrical portion of the head, structured to matingly engage with corresponding tabs or slots of the manifold. In the embodiment illustrated in FIG. 20, the cylindrical portion of the head also includes seals 404, the seals 404 structures to prevent fluid from the inlet and outlet portions of the head from leaking into the appliance and/or the manifold.

FIG. 21 illustrates a perspective view of a head, in accordance with an embodiment of the invention. As shown in FIG. 21, the base portion of the head may include a plurality of fins 414, the fins 414 extending towards the first end of the head. The head may include a first cylindrical portion at the first end of the head, and an adjacent second cylindrical portion, the second cylindrical portion having a larger diameter than the first cylindrical portion. Extending radially outwards from the perimeter of the first cylindrical portion may be at least one first key 408, and extending radially outwards from the second cylindrical portion may be at least one second key 406. The first and second keys 408, 406 may be structured to matingly engage with corresponding apertures and/or slots of the manifold. Proximate the first end of the head and adjacent the first cylindrical portion is a substantially cylindrical tip, structured with a first seal 410. The first seal 410 is positioned along the perimeter of the tip. Proximate the first cylindrical portion is a second seal 412, positioned along the perimeter of the first cylindrical portion. An inlet or an outlet of the head may be positioned between the first and second seals 410, 412, such that the first and second seals 410, 412 prevent fluid from the inlet or outlet from reaching areas of the manifold other than that which is between the first and second seals 410, 412.

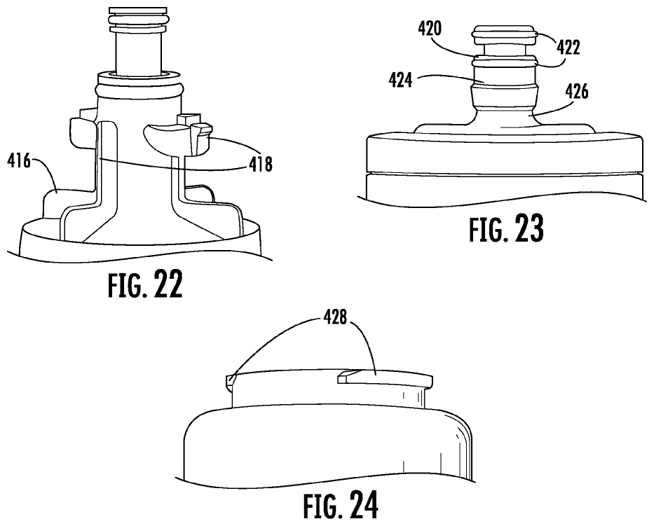

FIG. 22 illustrates a perspective view of a head, in accordance with an embodiment of the invention. As shown in FIG. 22, the head may comprise a plurality of protrusions 418 extending radially outward from a first cylindrical portion of the head, such as to matingly engage with corresponding apertures or slots in the manifold. Moreover, the head may include at least one rib 416, the at least one rib 416 structured to extend between the first cylindrical portion in the axial direction of the head and an adjacent base of the head extending in a primarily orthogonal direction from the cylindrical portion.

FIG. 23 illustrates a perspective view of a head, in accordance with an embodiment of the invention. As shown in FIG. 23, the head may include a first cylindrical portion 426 adjacent the base of the head, extending towards a first end of the head. The head may also include a second cylindrical portion 424 adjacent the first cylindrical portion 426, and a third cylindrical portion 420 adjacent the second cylindrical portion 424. In the embodiment shown in FIG. 23, the first cylindrical portion 426 and the third cylindrical portion 420 are smaller in diameter than the second cylindrical portion 424. Positioned on the first end of the second cylindrical portion 424 and the first end of the third cylindrical portion 420 are seals 422, the seals 422 structured to extend around the perimeter of the second and third cylindrical portions 424, 420, and having a substantially similar diameter.

FIG. 24 illustrates a perspective view of a head, in accordance with an embodiment of the invention. As shown in FIG. 24, the head may include a plurality of fins 428 extending radially outwards from a cylindrical portion of the head, the fins 428 structured to matingly engage with corresponding apertures or slots of the manifold in which the head of the reusable water filter cartridge is positioned.

FIG. 25 illustrates an exploded view of a water filter cartridge 430, in accordance with an embodiment of the invention. Water filter cartridge 430 may include a filter housing 444, and a head 432 coupled thereto. A seal 464 is sealingly engaged with both the interface mechanism 436 and the head 432. Adjacent the interface mechanism 436 is a filtration media 438, and an endcap 440 coupled thereto, in a slidable arrangement with filter housing 444. Positioned between the endcap 440 and an inner surface of the filter housing 444 is a spring 442. It shall be appreciated that any and all of the various components shown with respect to water filter cartridge 430, such as endcap 440, interface mechanism 436, spring 442, seal 464, filtration media 438, and head 432, may be substituted with corresponding components in alternate configurations as described throughout this disclosure. Additionally or alternatively, any of the aforementioned components such as endcap 440, interface mechanism 436, spring 442, seal 464, filtration media 438, and head 432 may be omitted from water filter cartridge 430. For example, the user may, after removing the filtration media 438 from the water filter cartridge 430, introduce cleaning fluid and/or a liquid solution (e.g., including the cleaning media) from a source by placing the source in fluid communication with the manifold of the appliance. In some embodiments, the water filter cartridge 430 and/or a similar device may be the source for cleaning fluid, liquid solution, cleaning media, and/or the like. Accordingly, the water filter cartridge 430 may be provided without filtration media 438 and/or endcap 440, and/or interface mechanism 436, and/or spring 442, and/or seal 464.

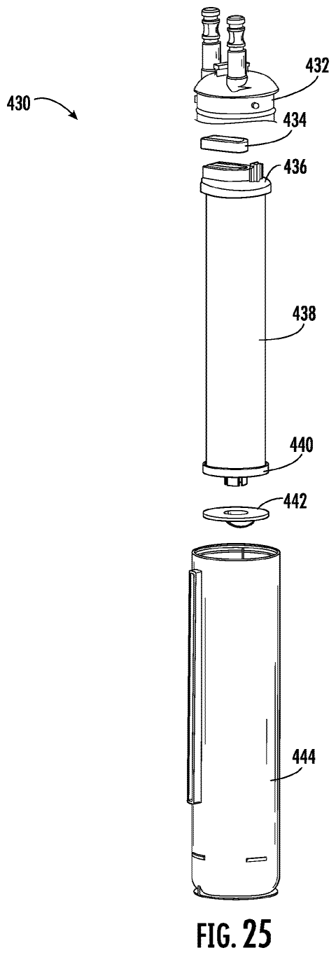

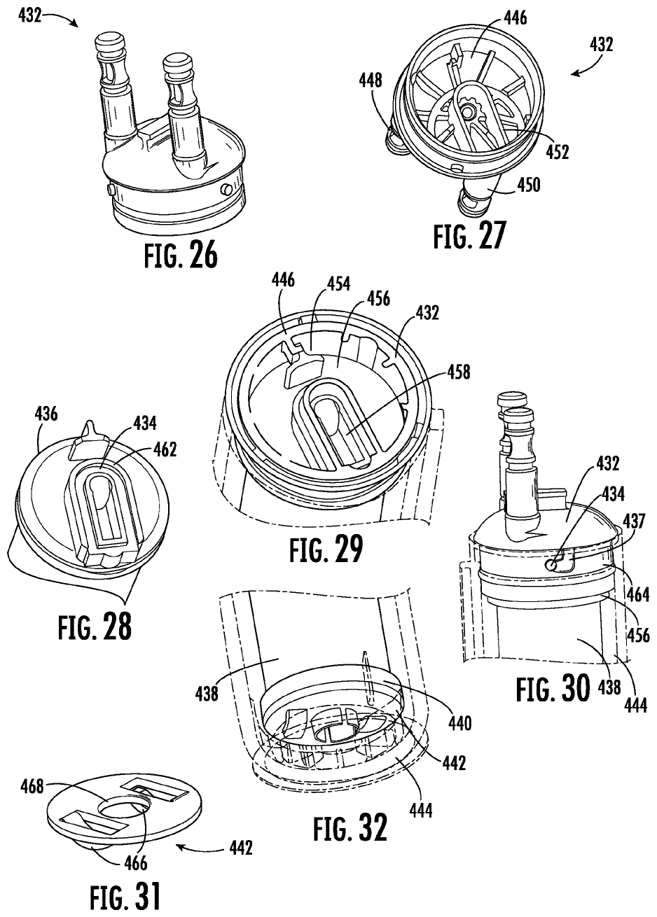

FIGS. 26-27 illustrate perspective views of a head 432 of water filter cartridge 430, in accordance with an embodiment of the invention. As shown in FIG. 27, head 432 may include a fluid inlet 448 and fluid outlet 450, configured to be in fluid communication with the cavity of the filter housing in order to transport a fluid such as water. The fluid inlet 448 and the fluid outlet 450 may be coupled to a head 432, which may, in some embodiments, be separable from the filter housing. Head 432 may also comprise one or more positioning features 446, structured to matingly engage with one or more corresponding stopper(s) 454 on the interface mechanism 436 as will be described herein with respect to FIG. 29.

Head 432 may also include a seal protrusion 452 extending from the internal cavity of head 432 towards the interface mechanism 436 when positioned in the water filter cartridge 430. The seal protrusion 452 is structured to sealingly engage with a seal 464 positioned in the interface mechanism 436, such as to isolate the inflow and/or outflow of fluid and prevent contamination of the inflow of fluid (e.g., unfiltered liquid) with the outflow of fluid (e.g., filtered liquid), and direct the inflow of fluid to the filtration media 438.

Referring now to FIGS. 28-30, the seal 464 may be positioned within a seal cavity 462 of the interface mechanism 436. The seal 464 may be fabricated of various types of rubber, composite, foam, or any other material suitable for achieving a liquid-tight interface between the one or more components of interface mechanism 436 and/or head 432. Liquid-tight sealing may occur as a result of compression and/or deformation of seal 464 against the adjacent surfaces of interface mechanism 436 and/or head 432 when forces in the longitudinal direction of the water filter cartridge, from the assembling of the interface mechanism 436 and/or head 432 with seal 464, induce material disposition between the seal 464 and the adjacent surfaces of interface mechanism 436 and/or head 432.

When assembled, a first end of interface mechanism 436 is positioned adjacent and coupled to the filtration media 438, while the second end of the interface mechanism 436 is positioned adjacent and coupled to the head 432. The interface mechanism 436 may include a stopper 454, which is a protrusion extending in the axial direction from the interface mechanism 436 towards the head 432 when in the assembled configuration. The stopper 454 is a material barrier which positions the interface mechanism 436 in the proper orientation relative to the head 432, by providing a corresponding positioning feature 446 on the head 432. In some embodiments, the positioning feature 446 and/or the stopper 454 may comprise a snapping or locking feature to prevent the unintended separation of the interface mechanism 436 from the head 432. As illustrated in FIG. 29, the interface mechanism 436 may also include aperture 458, the aperture 458 structured to direct incoming and/or outgoing liquid to or from the filtration media 438.

As illustrated in FIG. 30, head 432 may also include one or more protuberances 434, the protuberances 434 extending radially outward from the outer surface of head 432, and structured to matingly engage with slots 437 of the filter housing 444. The slots 437 are configured to receive protuberances 434, such that the head 432 is assembled by placing it in the longitudinal direction relative to the filter housing 444, pressing the head 432 downwards to sealingly engage the seal 464, then twisting the head 432 relative to the filter housing 444 to secure the head 432 to the filter housing 444. It shall be appreciated that in some embodiments, head 432 may also include seal 464 on the outer circumference of head 432, as previously described with respect to at least FIGS. 1-2A.

FIG. 31 illustrates a perspective view of a spring 442. As shown in FIGS. 31-32, in some embodiments the spring 442 may be positioned adjacent the endcap 440 and structured to be positioned between the endcap 440 and the filter housing 444, such that the spring 442 is coupled to both the filter housing 444 and the endcap 440. The spring 442 may include an aperture 468, configured to receive a corresponding protuberance from the endcap 440. Accordingly, when assembled, the protuberance from endcap 440 extends through the aperture 468 of the spring to be coupled to a corresponding aperture in the filter housing 444. The spring 442 may include one or more deflection tabs 466 which extend from one face of the spring 442, and are structured be placed adjacent a corresponding surface of the filter housing 444 and deflect (e.g., bend) when force is applied in the axial direction to the components inside the water filter cartridge 430. In this way, when force is applied to head 432 to facilitate the assembly of the water filter cartridge 430, force is transferred through the filtration media 438 to the spring 442, which causes deflection tabs 466 to deflect and prevent damage to the filtration media 438 from occurring. Furthermore, after assembly of the water filter cartridge 430, the deflection tabs 466 and the spring 442 apply a force in an axial direction toward the head 432 to press the interface mechanism 436 and the seal 464 against the head 432, thereby facilitating the formation of a liquid-tight seal via compression and/or deformation of seal 464 against the seal protrusion 452 of the head 432. In some embodiments, filter housing 444 may include recesses, channels, or apertures structured to receive the deflection tabs 466.

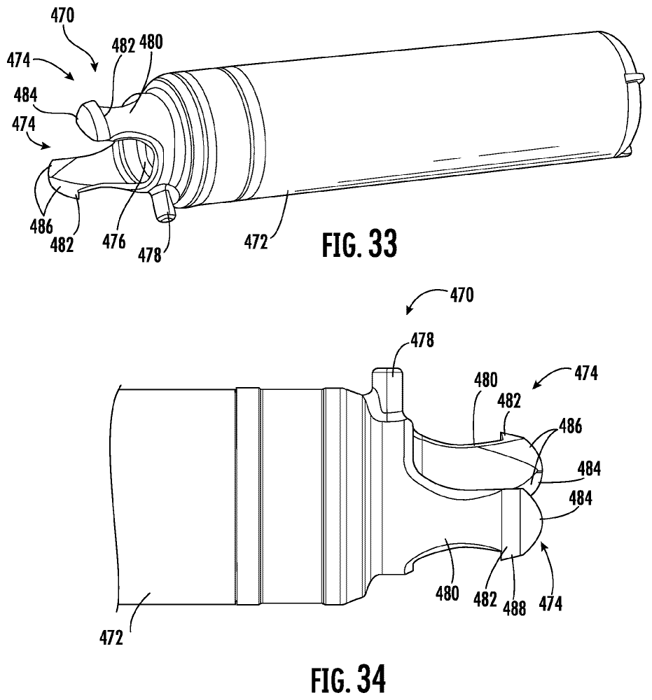

FIGS. 33-34 illustrate perspective views of a head, in accordance with an embodiment of the invention. As shown in FIG. 33, the filter cartridge may include a fluid inlet and outlet 476 as well as an head 470, which may be formed into the filter body 472 and/or attached to the filter body 472 as shown in FIG. 33. In some embodiments, the fluid inlet and outlet 476 may be formed in a central portion of the first end of the filter body 472, and the head 470 may be formed into the filter body 472 and/or attached to the filter body 472 at a peripheral portion of the first end of the filter body 472. In use, water may pass through the fluid inlet into the filter body 472, and pass through the fluid outlet to the appliance.

As shown in FIG. 33, the head 470 may include a key 478 and two displaceable latch features, depicted in FIG. 33 as flexible prongs 474. The displaceable latch features may, in some embodiments, have different features as compared to the flexible prongs 474 (e.g., rotating elements, latches, blocks, and/or the like). In some embodiments, the key 478 may extend radially outward from the head 470 (e.g., from an outer surface of the head 470 and/or the like). In some embodiments, the flexible prongs 474 may extend from the head 470 in a substantially longitudinal direction. Accordingly, in some embodiments, the flexible prongs 474 may define a fixed end and a free end, and extend in a substantially longitudinal direction therebetween. In some embodiments, the fixed end of the flexible prongs 474 may be positioned on a peripheral outer surface of the head 470. In other embodiments, the fixed end of the flexible prongs 474 may be positioned on a top surface of the head 470. In some embodiments, the flexible prongs 474 may be diametrically opposed relative the outer surface of the head 470.

In some embodiments, a latch surface is able to engage a sidewall of the channel of a corresponding manifold (not depicted in FIGS. 33-34) in a latched condition, and to be disengaged from the sidewall of the channel in a different position to allow the displaceable latch features to be removed from the receiver portion of the manifold. In some embodiments, and as described herein, once the first and second flexible prongs 474 are received in corresponding receptacles of a manifold, rotation of the filter cartridge in a first direction is prevented, while rotation of the filter cartridge in a second direction is permitted.

FIG. 34 illustrates a close-up, side view of the head 470 of the filter cartridge, in accordance with an embodiment of the invention. As shown in FIG. 34, each of the flexible prongs 474 may define neck portions 480 extending from a base. The neck portions 480 may be shaped to be more narrow at the portions defining the free ends of the flexible prongs 474 (referred to as the head portions 484) while being wider at the portions defining the fixed ends of the flexible prongs 474. The neck portions 480 may extend substantially parallel to the longitudinal axis in a direction opposite the insertion direction and a head portion at an end of the neck portion.

The free ends of the flexible prongs 474 may also include head portions 484, which are rounded to be received into receptacles of the manifold to be locked in place. The outer edge of the head portions 484 may extend radially outward beyond the neck portion, which may be received by a space (receptacles) in the manifold after insertion. Additionally, or alternatively, the head portions 484, as well as chamfers 486 may serve to align and orient the flexible prongs 474 during the installation and removal processes. This design feature enables a margin of imprecision in initial flexible prong placement, as the interfaces between flexible prongs 474 and the manifold are guided, thus allowing subsequent correction to achieve the intended precise positioning.

Additionally, or alternatively, and as also shown in FIG. 34, the free ends of the flexible prongs 474, may include latch features 482 which provide a flared edge. The edge of the head portion may extend radially outward from the neck portion, which may permit the latching latch features 482 to sit in the receptacles and prevent movement of the filter cartridge in a direction opposite the insertion direction.

As shown in FIGS. 33 and 34, the key 478 may be shaped as an extruded cylinder, and, as described further herein, the key 478 may interact with a keyway in a tube of the filter cartridge manifold. In some embodiments, the key 478 may have a cylindrical-shape with a beveled and/or curved outer edge where the sidewalls of the cylinder meet the circular end of the key 478 (e.g., the upward-facing surface in the orientation shown in FIG. 34).

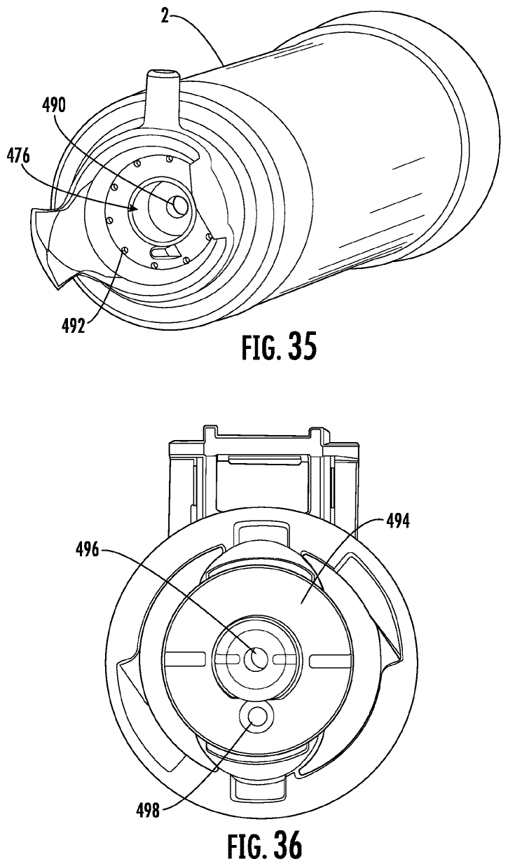

Referring now to FIGS. 35 and 36, head 470 interfaces with the cavity of the filter housing and the manifold 494 in a manner similar to that described herein with respect to FIGS. 1-3C. However, rather than having a fluid inlet and outlet extending outward from the head as shown in FIGS. 1-3C, the fluid inlet and outlet 476 may include a central opening 490 in the head for receiving water from the manifold 494 and a plurality of holes 492 positioned in a ring-shape radially offset from the central opening 490 for providing filtered water to the manifold.

As previously described with respect to various other embodiments, the cleaning media, cleaning fluid, or liquid solution may be placed inside the filter housing 2 as a result of accessing the cavity of the filter housing 2 by removing the cap 8. Additionally, or alternatively, head 470 may be removed to access the cavity. In some embodiments, water filter cartridge 100 may be pre-filled with cleaning media, cleaning fluid, or liquid solution such that removal of the head 470 or cap 8 is not necessary.

After the water filter cartridge 100 has been positioned within a manifold 494 of an appliance, the fluid inlet and outlet 476 may be in fluid communication with the manifold 494. Unfiltered fluid from the manifold 494 passes through the manifold hole 496, and through central opening 490 of the head 470. The central opening 490 is in fluid communication with at least a portion of the cavity within the filter housing 2, which may contain the cleaning media, cleaning fluid, or liquid solution. The cleaning fluid (e.g., liquid solution) then exits the water filter cartridge 100 through the plurality of holes 492 in the head 470 and is directed into the bottom hole 498 of the manifold.

FIG. 37 illustrates perspective views of a pre-form for a water filter cartridge and a resulting thin-walled water filter cartridge, in accordance with an embodiment of the invention. While the various embodiments disclosed herein may include heads of water filter cartridges and cartridges that are either (i) formed integrally with the cartridge, or (ii) formed separately from the cartridge and subsequently affixed to the cartridge via plastic welding, swaging, adhesives, and/or the like, it shall be appreciated that there may be advantages to low-cost, one-time or limited use water filter cartridges, such that the water filter cartridge may be applied to the manifold of the appliance specifically for purposes of cleaning the water lines and other components of the appliance, then subsequently discarded, recycled, reused, or stored for a limited number of subsequent uses.

Accordingly, an economically-efficient water filter cartridge 502 may be desired, in some embodiments pre-filled with cleaning media to reduce the number of steps that an end user must complete to use the water filter cartridge 502 in a cleaning cycle. As previously described, the cleaning media may include a liquid solution, a concentrated cleaning fluid, or a solid concentrate to be dissolved to form the cleaning fluid. It shall similarly be understood that any of the embodiments of water filter cartridges described herein may be configured as a water filter cartridge 502 such that the head 510 may take any number of the embodiments as described herein.

As such, although the embodiments shown in FIGS. 37 and 38 refer to a water filter cartridge, it shall be understood that some embodiments may not contain any filtration cartridge therein, and instead contain cleaning media, cleaning fluid, or liquid solution.

As illustrated in FIG. 37, the water filter cartridge 502 may be formed in a thin-walled configuration, composed of a thermoplastic or a similar material, formed to define a cavity 504 therein to receive and retain the cleaning media. In such embodiments, the water filter cartridge 502 may be provided pre-filled with cleaning media in the cavity 504. The water filter cartridge may be formed of various materials, specifically thermoplastics such as those used for molding bottles, including but not limited to polyethylene terephthalate (“PET”), high-density polyethylene (“HDPE”), polyvinyl chloride (“PVC”), and polypropylene (“PP”). As will be described in detail in reference to FIG. 38, prior to the forming of the water filter cartridge 502, the water filter cartridge may be provided as a pre-form 500, with various features such as the head 510 having been injection molded. The pre-form 500 may then subsequently be subjected to a blow-molding or similar process to inject a gas into the pre-form 500, thereby forming the cavity 504 for receiving the cleaning media.

FIG. 38 illustrates a forming process of a pre-form 500 for a water filter cartridge and a resulting thin-walled water filter cartridge 502, in accordance with an embodiment of the invention. The process illustrated in FIG. 38 is one of blow-molding. At step A of the process, a thermoplastic pre-form 500 is supplied to the blow-molding apparatus. This pre-form has been previously injection molded, rotary-molded, or the like. In some embodiments, this pre-form includes ahead 510 and any necessary attachment features required for connecting the water filter cartridge 502 to the manifold. In other embodiments, the head 510 may be a separate body that is attached via a post-processing step to the thin-walled body produced as a result of the blow-molding described herein. The pre-form also contains a pre-form void. In some embodiments, the blow-molding apparatus may include a retaining feature structured to be coupled to and retain the head 510. In some embodiments, the blow-molding apparatus includes a molding chamber (e.g., including mold pieces 508A and 508B) for shaping the remainder of the water filter cartridge 502 through the blow-molding process. The blow-molding apparatus may also include an injection device 506 for injecting gases, such as air into the pre-form void. In some embodiments, the injection device 506 may also inject fluids, such as the cleaning media described herein, into the cavity 504 formed during blow molding process.

To aid the blow-molding process, the pre-form 500 and the thermoplastic material it consists of may be heated to its melting point, glass transition, or another predetermined temperature suitable for flowing molten plastic. This heating can take place either before the pre-form 500 enters the mold of the blow-molding apparatus, or within the blow-molding apparatus itself, depending on the specific embodiment.

At step B, the injection device 506 of the blow-molding apparatus injects gas into the pre-form void. Due to the prior heating and the introduction of gas, the thermoplastic material inside the pre-form 500 expands volumetrically. This expansion results in a reduction in the wall thickness between the exterior surface of the pre-form 500 and the pre-form void.

Step C involves the continued injection of pressurized gas into the void. This process is carried out until the exterior portion of the pre-form 500 reaches the inner walls of the mold pieces 508A and 508B. This step imparts the desired geometric features of the mold onto the workpiece, shaping it into the intended water filter cartridge 502. While FIG. 38 illustrates a two-piece mold, it shall be appreciated that any number of mold cavities may be implemented, including but not limited to 1-piece, 2-piece, 3-piece, and 4-piece, which, when combined, provide a cavity matching the desired geometrical shape of the resulting water filter cartridge 502. In some embodiments, Step C may further include the injection of fluid(s) by the injection device 506, such as the cleaning media, cleaning fluid, or liquid solution described herein, during or after the continued injection of gas into the void.

At step D, the mold pieces 508A and 508B are retracted from the now-formed water filter cartridge 502. This leaves behind the thin-walled water filter cartridge 502 as the end product of the blow-molding process.

In some embodiments, cleaning media, cleaning fluid, or liquid solution may be introduced into the cavity 504 of the water filter cartridge 502 while it remains within the mold. Alternatively, a separate filling apparatus can be used subsequent the use of the blow-molding apparatus to inject the cleaning media into the cavity 504. Subsequently, one or more removable seals may be applied to the inlet and outlets of the head 510 of the cartridge 502 to prevent any leakage of the cleaning media before the water filter cartridge 502 is used.

As previously described, in some embodiments the head 510 is a separate body attached via a post-processing step to the thin-walled body produced as a result of the steps A-D above. Accordingly, an additional processing step to affix to the head 510 to the thin-walled body, via plastic welding, swaging, adhesives, or the like, to form the water filter cartridge 502.

### INCORPORATION BY REFERENCE

To supplement the present disclosure, each of the following patents, patent publications, and patent applications, is incorporated herein by reference in its entirety: U.S. Pat. Nos. 10,022,658B2; 10,010,820B1; 9,937,451B2; 8,950,052B2; 8,845,896B2; 8,591,736B2; 8,413,818B1; 8,356,716B1; 7,610,932B2; 7,147,773B2; 7,000,894B2; RE46,554E1; 7,799,220B2; 8,182,699B2; 9,872,584B2; D772,379S1; D472,299S1; 9,687,762B2; 9,345,995B2; 5,907,958A; 9,366,388B2; 10,603,612B2; 10,913,020B2; 10,905,989B2; 10,272,370B2; 9,242,195B2; 9,027,361B2; 8,955,349B2; 10,946,319B2; 9,993,757B2; 10,737,206B2; D735,294S1; 9,901,854B1; 7,823,407B2; 9,494,362B2; 9,487,414B2; 8,496,823B2; 9,320,993B2; 10,967,313B2; U.S. Published Application Nos. US20120211412A1; US20180056216A1; US20180304181A1; US20210178297A1; US20150157967A1; US20100000919A1; US20210299600A1; US20200139280A1; US20150258476A1; U.S. patent application Ser. Nos. 29/786,024; 29/786,025; 29/786,026; 29/786,027; 17/333,124; and U.S. Provisional Application Ser. No. 63/423,971.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the invention. Therefore, it is to be understood that, within the scope of the appended claims, the invention may be practiced other than as specifically described herein.

1. A cartridge for cleaning water lines of an appliance, the cartridge comprising:
a housing defining a cavity;
a fluid inlet and a fluid outlet positioned on the housing and in fluid communication with the cavity, wherein the fluid inlet and the fluid outlet are configured to interface with a water filter cartridge manifold of an appliance; and
a cleaning media disposed within the cavity.

2. (canceled)

3. The cartridge of claim 1, wherein the housing is configured to provide access to the cavity.

4. (canceled)

5. The cartridge of claim 1, wherein the housing further comprises:
at least one displaceable latch feature extending longitudinally from the housing.

6-7. (canceled)

8. The cartridge of claim 1, wherein the cleaning media is a liquid solution to be delivered through the water filter cartridge manifold to one or more water lines.

9. The cartridge of claim 1, wherein the cleaning media is formulated to be diluted in water, while the fluid inlet and the fluid outlet interface with the water filter cartridge manifold, to form a liquid solution before delivery through the water filter cartridge manifold to one or more water lines.

10-13. (canceled)

14. The cartridge of claim 8, wherein the liquid solution comprises peracetic acid.

15. The cartridge of claim 8, wherein the liquid solution has a concentration of about 5 percent or less of peracetic acid.

16-18. (canceled)

19. The cartridge of claim 8, wherein the one or more water lines of the appliance have a total length, and wherein the cleaning media is formulated such that the liquid solution has sufficient concentration of the cleaning media through the total length of the one or more water lines to reduce a bacterial count in the one or more water lines of the appliance.

20. The cartridge of claim 8, wherein the one or more water lines of the appliance have a total length, and wherein the cleaning media is formulated such that the liquid solution has sufficient concentration of the cleaning media through the total length of the one or more water lines to substantially eliminate bacteria in the one or more water lines of the appliance after the liquid solution is positioned within the one or more water lines for at least a predetermined period of time.

21-48. (canceled)

49. A method for cleaning water lines of an appliance, the method comprising:
introducing cleaning fluid from a source into water lines of an appliance, wherein the source comprises a container of the cleaning fluid, and wherein the container is attached to a water filter cartridge manifold of the appliance;
after introducing the cleaning fluid from the source, waiting at least a predetermined period of time; and
after waiting at least the predetermined period of time, introducing water into the water lines to push the cleaning fluid out of the water lines.

50. The method of claim 49, further comprising introducing additional water into the water lines to rinse the water lines.

51. The method of claim 49, wherein the cleaning fluid comprises a cleaning chemical.

52. (canceled)

53. The method of claim 51, wherein the cleaning fluid has a concentration of the cleaning chemical of at least about 0.01 percent throughout a whole length of one or more of the water lines.

54. The method of claim 49, wherein introducing the cleaning fluid from the source into the water lines of the appliance comprises introducing the cleaning fluid from the source to substantially fill one or more of the water lines of the appliance.

55. The method of claim 49, wherein the container comprises concentrate, and wherein the method comprises, before introducing the cleaning fluid from the source into the water lines of the appliance, introducing water into the container to dilute the concentrate to form the cleaning fluid.

56. The method of claim 49, wherein the container comprises solid concentrate, and wherein the method comprises, before introducing the cleaning fluid from the source into the water lines of the appliance, introducing water into the container to dissolve the solid concentrate to form the cleaning fluid.

57-70. (canceled)

71. An appliance, comprising:
a water filter cartridge manifold configured to receive a water filter cartridge;
one or more water lines in fluid communication with the water filter cartridge manifold;
at least one processing device; and
at least one non-transitory storage device comprising computer-executable program code that, when executed by the at least one processing device, causes the at least one processing device to:
introduce, through the water filter cartridge manifold, cleaning fluid from a source into the one or more water lines;
after introducing the cleaning fluid from the source, wait at least a predetermined period of time; and
after waiting at least the predetermined period of time, introduce, through the water filter cartridge manifold, water into the one or more water lines to push the cleaning fluid out of the one or more water lines.

72. (canceled)

73. The appliance of claim 71, wherein the appliance is a refrigerator.

74. The appliance of claim 71, wherein the at least one non-transitory storage device comprises computer-executable program code that, when executed by the at least one processing device, causes the at least one processing device to introduce additional water into the one or more water lines to rinse the one or more water lines.

75. The appliance of claim 71, wherein the at least one non-transitory storage device comprises computer-executable program code that, when executed by the at least one processing device, causes the at least one processing device to, when introducing the cleaning fluid from the source into the one or more water lines of the appliance, introduce the cleaning fluid from the source to substantially fill the one or more of the water lines of the appliance.
